(19) United States
(12) Patent Application Publication
(10) Pub. No.: US 2026/0299184 A1
(43) Pub. Date: Oct. 1, 2026

(54) LIGHT GUIDE PLATE AND DISPLAY ASSEMBLY

(71) Applicants: YANCHENG NICROTEK CO., LTD., Yancheng Jiangsu (CN); NICROTEK CO., LTD., Suzhou, Jiangsu (CN); VISEN NEW MATEERIALS CO., LTD., Yancheng, Jiangsu (CN); SUZHOU ZHONGWEI LIANCHUANG INNOVATION CENTER FOR MICRO-NANO MANUFACTURING C, Suzhou, Jiangsu (CN); SOOCHOW UNIVERSITY, Suzhou, Jiangsu (CN)

(72) Inventors: Zongbao FANG, Suzhou (CN); Hui FANG, Suzhou (CN); Heng ZHANG, Suzhou (CN)

(21) Appl. No.: 18/874,118

(22) PCT Filed: Aug. 29, 2022
(86) PCT No.: PCT/CN2022/115373

§ 371 Date: Dec. 12, 2024

(30) Foreign Application Priority Data
Jun. 27, 2022 (CN) 202210738453.9
Jun. 27, 2022 (CN) 202221628421.5

(51) Int. Cl. F21V 8/00

(52) U.S. Cl. CPC G02B 6/0038

(57) ABSTRACT

A light guide plate (33) includes a bottom surface (11), a light exit surface (13) and a light incident surface (15). The bottom surface (11) and the light exit surface (13) are arranged opposite to each other, and the light incident surface (15) connects the bottom surface (11) and the light exit surface (13). A plurality of microstructures are formed on the bottom surface (11). The microstructure includes a protruding part (19) and a concave part (17). The protruding part (19) protrudes towards the side facing away from the light exit surface (13). The concave part (17) caves in towards the light exit surface (13). The concave part (17) includes a first surface (171) facing the interior of the light guide plate (33), and the first surface (171) faces the light incident surface (15).

The application claims priority to Chinese Patent Application No. 202210738453.9 and Chinese Patent Application No. 202221628421.5, entitled “Light Guide Plate and Display Assembly”, filed on Jun. 27, 2022, both of which are incorporated herein by reference in its entirety.

### TECHNICAL FIELD

The invention relates to the technical field of display, in particular to a light guide plate and a display assembly.

### BACKGROUND

Light exits from an edge-lit light guide plate by destroying the Total Internal Reflection (TIR) in the light guide plate. A conventional solution for destroying the TIR in the edge-lit light guide plate is to provide microstructures on the bottom surface of the light guide plate to reflect light entering the light guide plate so as to change the direction of light propagation and allow the light exiting from the light exit surface of the light guide plate with a large viewing angle.

At present, the luminous intensity peak of light exiting from the light exit surface of the light guide plate is at about 80°, that is, light exits from the light guide plate with a large viewing angle, leading to a lower on-axis luminous intensity distribution of the light guide plate. For transmissive liquid crystal display, to maximize luminous intensity, especially the on-axis luminous intensity of the light guide plate, two layers of brightness enhancement films (BEFs) are often used to concentrate luminous intensity exiting from light guide plate with a larger viewing angle and refract the concentrated luminous intensity into axial viewing. However, the arrangement of the brightness enhancement films will lead to multilayer films and a complex structure and assembly process of a backlight unit, thus lowering the yield of finished products; and this will also lead to lower light use efficiency and other problems.

In a scenario of reflective liquid crystal display (RLCD), due to the characteristics of the reflective liquid crystal display screen, light is required to enter the liquid crystal display screen with a certain angle, so the exiting angle from the light guide plates needs to be adjusted particularly, for example to 15°, to guarantee the display performance of the liquid crystal display screen.

### SUMMARY OF THE INVENTION

To overcome the shortcomings and defects in the prior art, the objective of the invention is to provide a light guide plate and a display assembly to improve the light coupling efficiency, simplify the structure of a backlight unit and improve the light use efficiency.

The objective of the invention is fulfilled by the following technical solution: the invention provides a light guide plate, comprising a bottom surface, a light exit surface and a light incident surface, wherein the bottom surface and the light exit surface are arranged opposite to each other, the light incident surface connects the bottom surface and the light exit surface, and a plurality of microstructures are formed on the bottom surface; and the microstructure comprises a protruding part and a concave part, the protruding part protrudes towards a side facing away from the light exit surface, the concave part caves in towards the light exit surface, the concave part comprises a first surface facing an interior of the light guide plate, the first surface faces the light incident surface, the concave part comprises a second surface facing the interior of the light guide plate, and the second surface is an extended surface of the first surface.

Further, section lines, in a reference plane perpendicular to the light incident surface and the light exit surface, of the first surface and the second surface form a first straight line and/or a first arc, and an included angle between the first straight line and the bottom surface or between a tangent of the first arc and the bottom surface is 0.5°-55°.

Further, section lines, in a reference plane perpendicular to the light incident surface and the light exit surface, of the first surface and the second surface form a first straight line and/or a first arc, wherein,
an included angle between the first straight line and the bottom surface or between a tangent of the first arc and the bottom surface is 0.5°-55°; or, an included angle between the first straight line and the bottom surface or between a tangent of the first arc and the bottom surface is 5°-35°; or, an included angle between the first straight line and the bottom surface or between a tangent of the first arc and the bottom surface is 35°-55°; or, an included angle between the first straight line and the bottom surface or between a tangent of the first arc and the bottom surface is 30°-50°.

Further, the concave part is in the shape of a truncated cone formed by partially cutting away a top and a side of a cone, a top surface of the truncated cone inclines with respect to an axis of the truncated cone and intersects with a bottom surface of the truncated cone at a point, the bottom surface of the truncated cone is perpendicular to the axis of the truncated cone, and the top surface forms the first surface; or, the concave part is in the shape of a truncated cone formed by partially cutting away a top and a side of a cone, a top surface of the truncated cone inclines with respect to an axis of the truncated cone and intersects with a bottom surface of the truncated cone along a straight line, the bottom surface of the truncated cone is perpendicular to the axis of the truncated cone, and the top surface forms the first surface; or, the concave part is in the shape of a semicylinder formed by partially cutting away a top and a side of a cylinder, a top surface of the semicylinder inclines with respect to an axis of the semicylinder and intersects with a bottom surface of the semicylinder at a point, and the top surface forms the first surface; or, the concave part is in the shape of a cylinder, a top surface of the cylinder inclines with respect to an axis of the cylinder and intersects with a bottom surface of the cylinder at a point, and the top surface forms the first surface; or, the concave part in the shape of a semicylinder formed by partially cutting away a top and a side of a cylinder, a top surface of the semicylinder inclines with respect to an axis of the semicylinder and intersects with a bottom surface of the semicylinder along a straight line, and the top surface forms the first surface; or, the concave part is in the shape of a hemispheroid formed by partially cutting away a dome of a spheroid from two different angles, a top surface formed by partially cutting away the dome of the spheroid from one angle inclines with respect to a bottom surface of the hemispheroid, and the top surface of the hemispheroid forms the first surface; or, the concave part is in the shape of a hemispheroid formed by partially cutting away a dome of a spheroid, a top surface formed by partially cutting away the dome of the spheroid inclines with respect to a bottom surface of the hemispheroid, and the top surface of the hemispheroid forms the first surface.

Further, a depth of the concave part of the microstructure is 0.5 μm-20 μm, a height of the protruding part is 0.2 μm-3 μm, and a ratio of the depth of the concave part to the height of the protruding part of the microstructure is 4-12; or, a depth (H1) of the concave part of the microstructure is 0.2 μm-3 μm, a height (H2) of the protruding part is 0.5 μm-20 μm, and a ratio of the depth (H1) of the concave part to the height (H2) of the protruding part of the microstructure is 1/12-¼.

Further, a length of the microstructure is 10 μm-150 μm, and a first width of the microstructure is 10 μm-150 μm, wherein the length refers to a size of the microstructure in a direction perpendicular to the light incident surface, and the first width refers to a size of the microstructure in a direction parallel to the light incident surface and the light exit surface.

Further, the microstructure further comprises a third surface, the first surface is connected to the third surface, and part of the third surface and the first surface are two sides of the concave part respectively.

Further, a section line, in a reference plane perpendicular to the light incident surface and the light exit surface, of the third surface is a second straight line, a second arc or a broken line, and an included angle between the second straight line and the bottom surface, between a tangent of the second arc and the bottom surface, or between the broken line and the bottom surface is 40°-80°.

Further, a section line, in a reference plane parallel to the bottom surface, of the third surface on is a straight line; or, at least part of the third surface is a conical surface, and at least part of a section line, in a reference plane parallel to the bottom surface, of the third surface is an arc.

Further, section lines, in a reference plane perpendicular to the light incident surface and the light exit surface, of the first surface and the third surface are in arc transition; and/or, arc transition is formed at a vertex of the protruding part.

The invention further provides a display assembly, comprising a light source, a light guide plate and a transmissive liquid crystal display panel, wherein the light guide plate is any one light guide plate described above, the light source is arranged on a side of the light incident surface of the light guide plate, and the light guide plate is located on a backlight side of the transmissive liquid crystal display panel.

The invention further provides a display assembly, comprising a light source, a light guide plate and a reflective liquid crystal display panel, wherein the light guide plate any one light guide plate described above, the light source is arranged on a side of the light incident surface of the light guide plate, and the light guide plate is located on a light exit side of the reflective liquid crystal display panel.

The invention has the following beneficial effects: according to the light guide plate and the display assembly provided by the invention, the microstructures comprising the concave parts and the protruding parts are formed on the bottom surface of the light guide plate, and the first surfaces and the second surfaces are used together to enlarge the area of an effective reflecting surface, thus improving the light coupling efficiency; moreover, the protruding parts can prevent adsorption between the light guide plate and other films and the top whitening phenomenon; in addition, when the light guide plate is applied to a transmissive liquid crystal backlight unit, a brightness enhancement film can be omitted, thus reducing film layers of the backlight unit, simplifying the structure and assembly process and improving the light use efficiency; and when the light guide plate is applied to a reflective liquid crystal front-light unit, the splitting ratio and luminous intensity on the axial viewing angle can be improved.

### SUMMARY OF THE INVENTION

### Technical Problem

### Problem-Solving Document

### Intentional Effect of the Invention

### BRIEF DESCRIPTION OF THE DRAWINGS

### Description of the Drawings

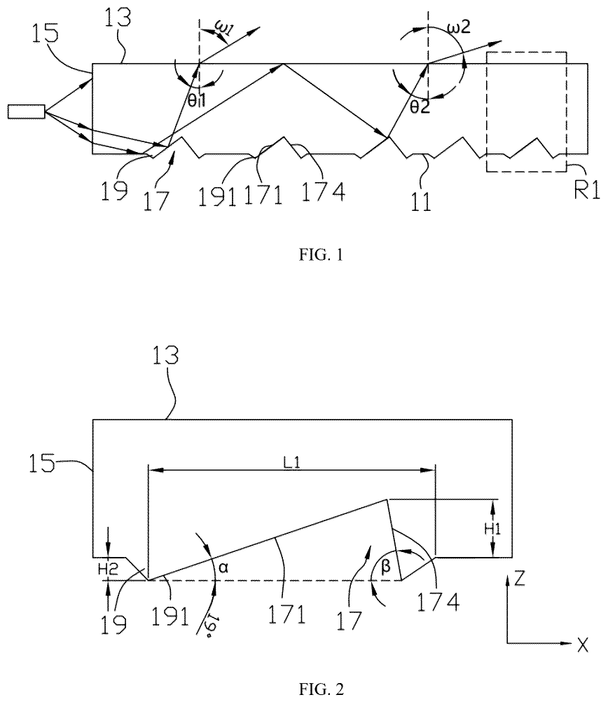

FIG. 1 is a schematic diagram of a light guide plate according to Embodiment 1 of the invention.

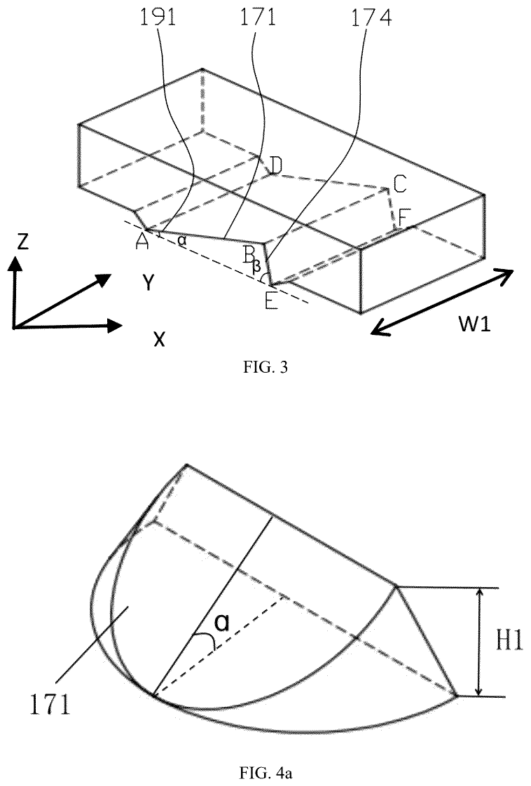

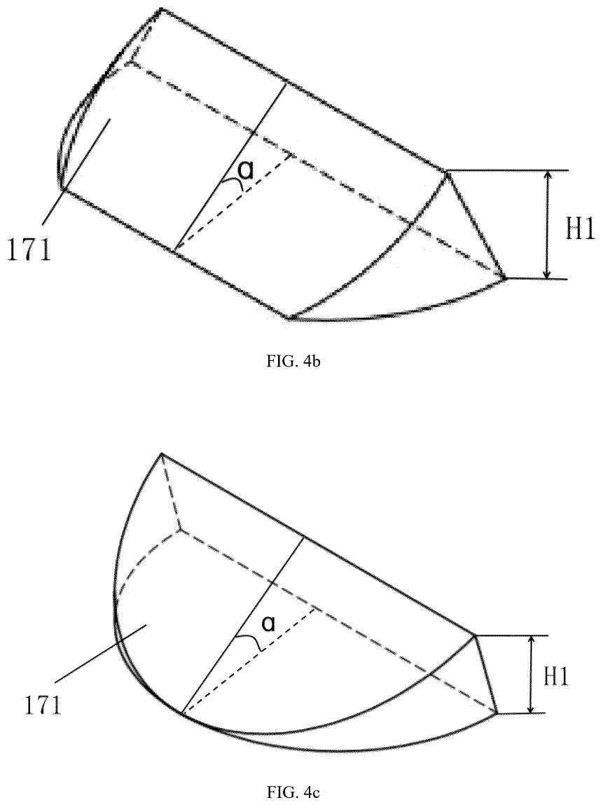

FIG. 2 is a partial schematic diagram of the microstructures on the light guide plate in FIG. 1.

FIG. 3 is a stereogram of the microstructures on the light guide plate in FIG. 1.

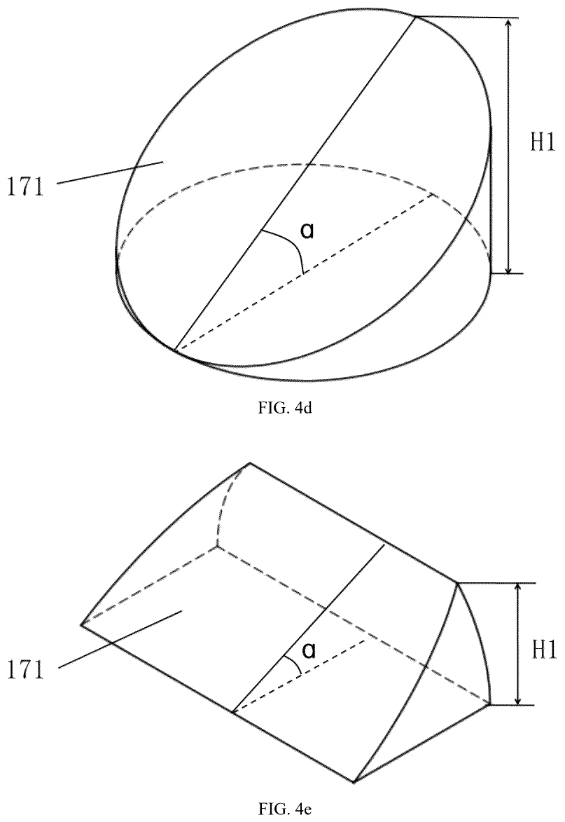

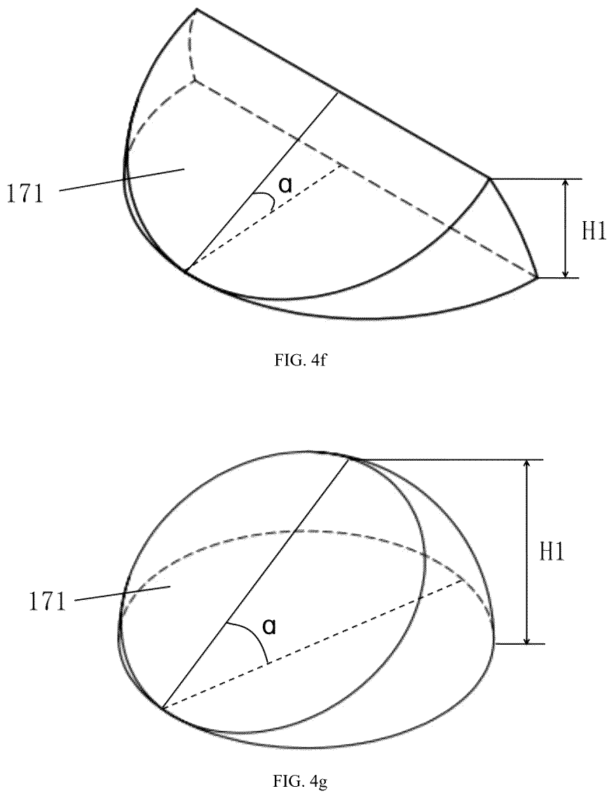

FIGS. 4a-4g are schematic diagram of a concave part of a microstructure of the light guide plate in FIG. 1 according to other embodiments.

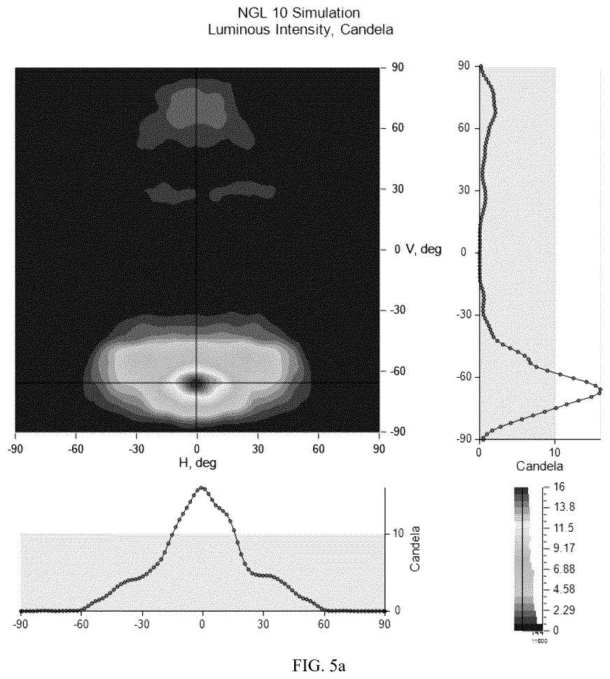

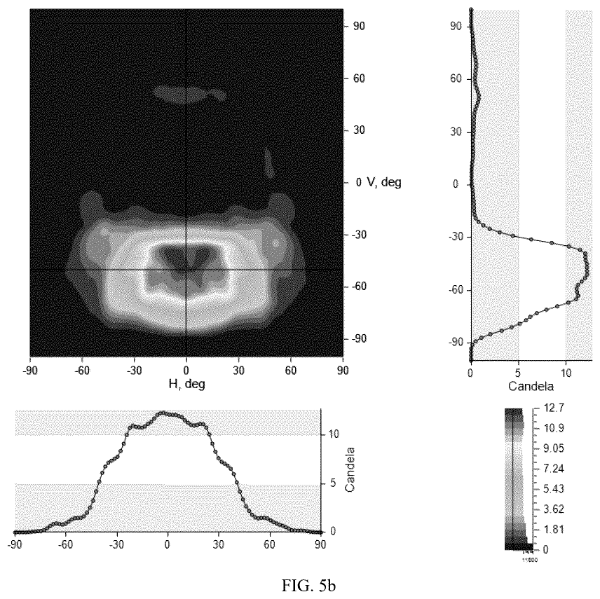

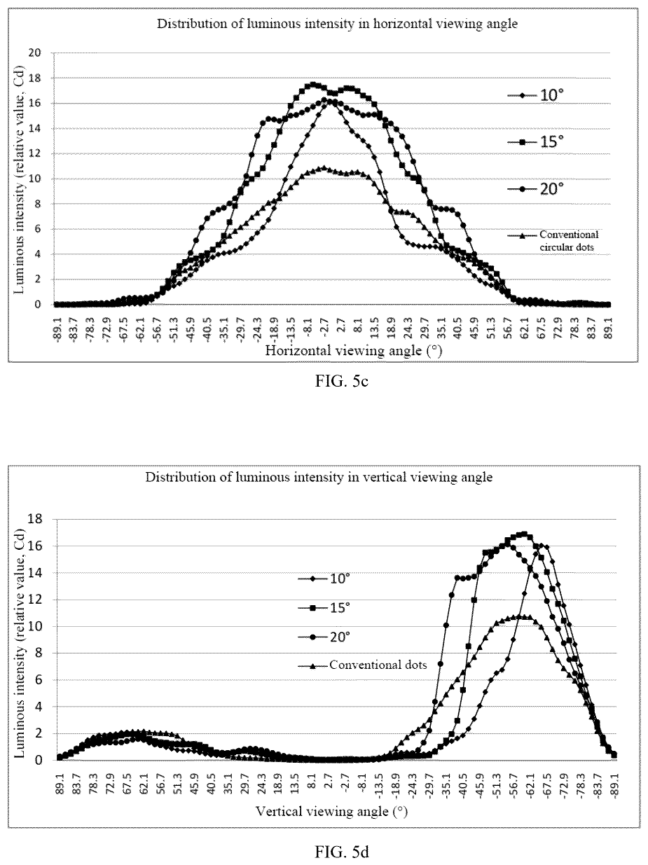

FIG. 5a illustrates a luminous intensity distribution of the light guide plate in FIG. 1.

FIG. 5b illustrates a luminous intensity distribution of a conventional light guide plate.

FIGS. 5c and 5d illustrate the luminous intensity distribution of the light guide plate in FIG. 1 with different tilt angles and the conventional light guide plate in a horizontal viewing angle and a vertical viewing angle, respectively.

FIG. 5e illustrates a relation between the tilt angle of a reflecting surface of the microstructure of the light guide plate in FIG. 1, an emission angle of a light source, and reflection times.

FIGS. 5f and 5g respectively illustrate a projection of the microstructure of the light guide plate in FIG. 3 in an XY plane and a projection of the microstructure in a YZ plane.

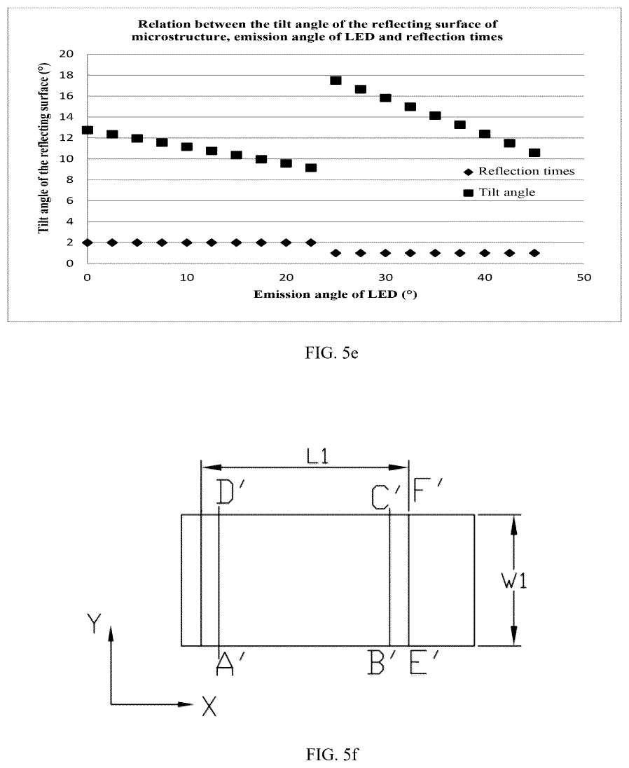

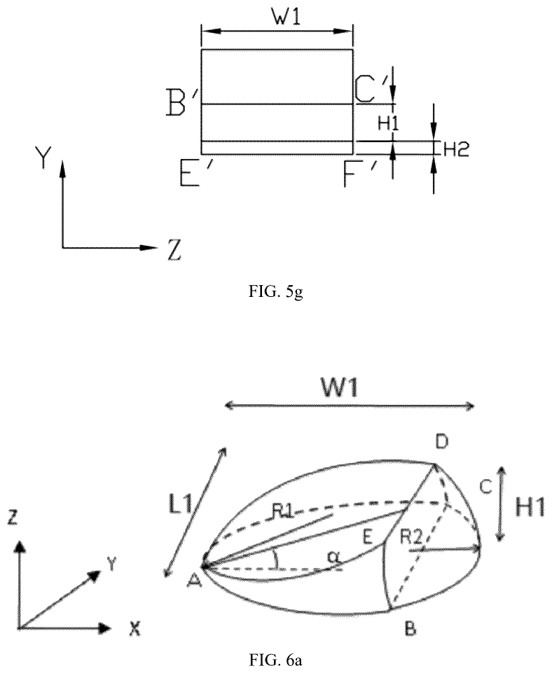

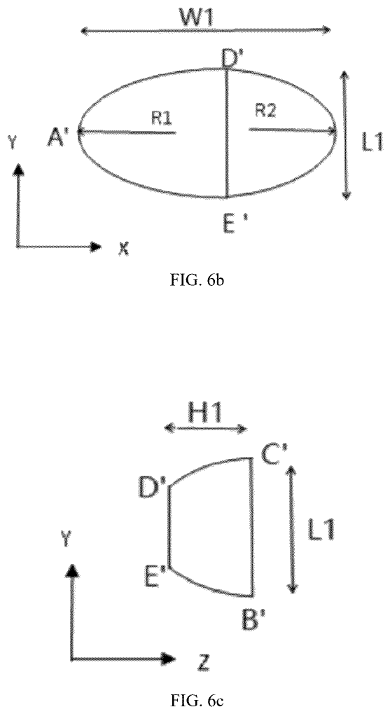

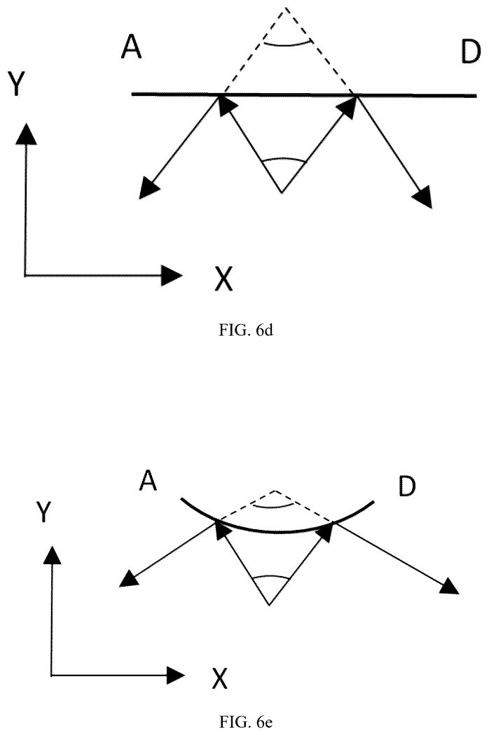

FIG. 6a is a structural view of an arc-shaped microstructure.

FIG. 6b illustrates a projection of the microstructure in FIG. 6a in an XY plane.

FIG. 6c illustrates a projection of the microstructure in FIG. 6a in a YZ plane.

FIG. 6d is a schematic diagram of the ray tracing of light reflected by the microstructure of the light guide plate in FIG. 3.

FIG. 6e is a schematic diagram of the ray tracing of light reflected by the microstructure in FIG. 6a.

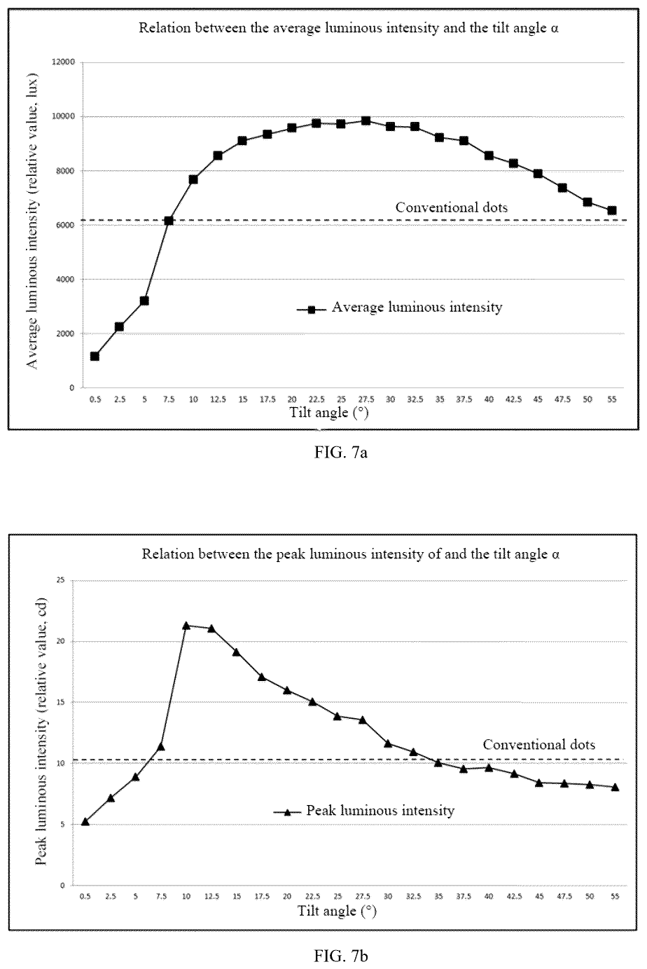

FIG. 7a is a comparison chart of the average luminous intensity in case of different tilt angles α of the microstructure on the light guide plate in FIG. 1 and the average luminous intensity of the conventional light guide plate.

FIG. 7b is a comparison chart of the peak luminous intensity of in case of different tilt angles α of the microstructure on the light guide plate in FIG. 1 and the peak luminous intensity of the conventional light guide plate.

FIG. 7c is a curve chart of the FWHM of luminous intensity in case of different tilt angles α of the microstructure on the light guide plate in FIG. 1.

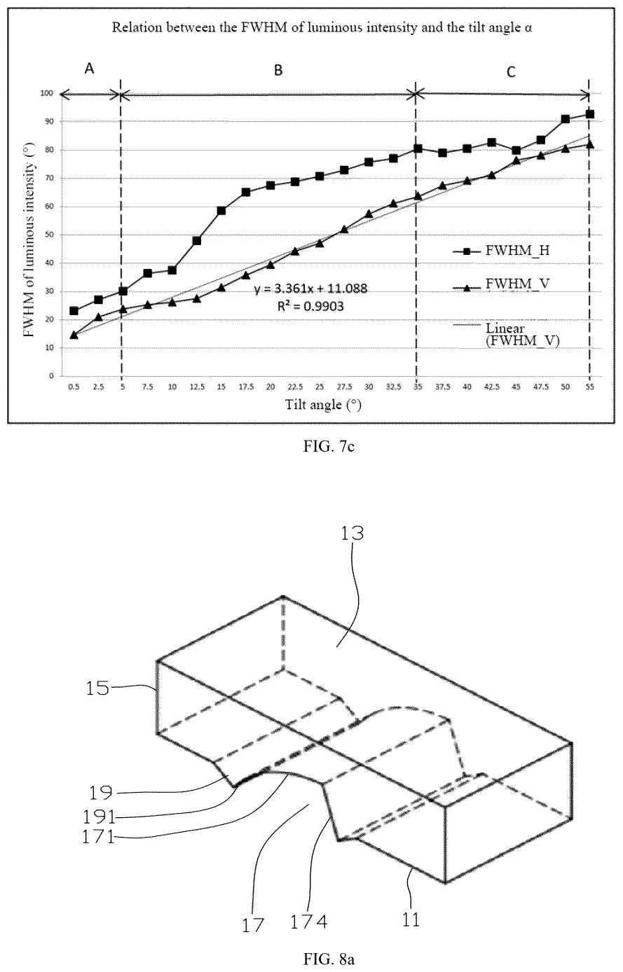

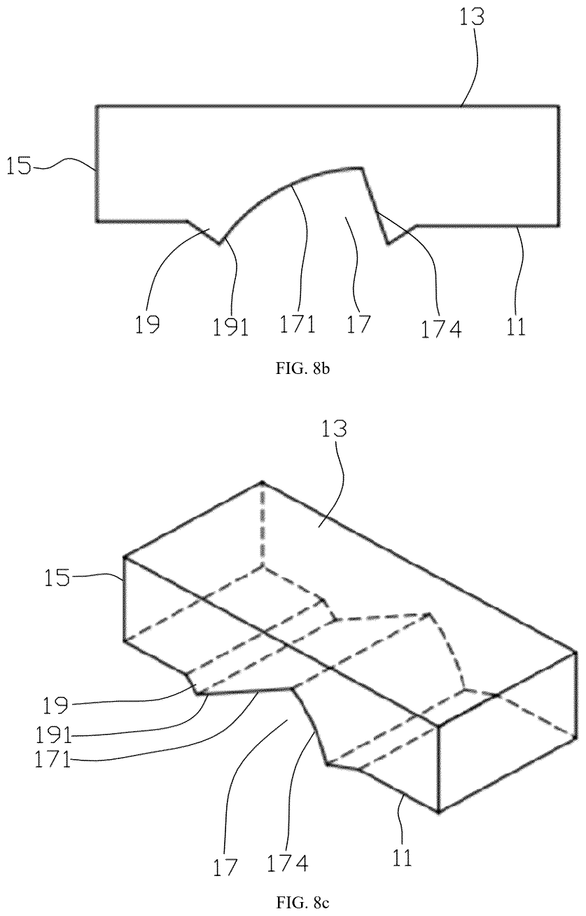

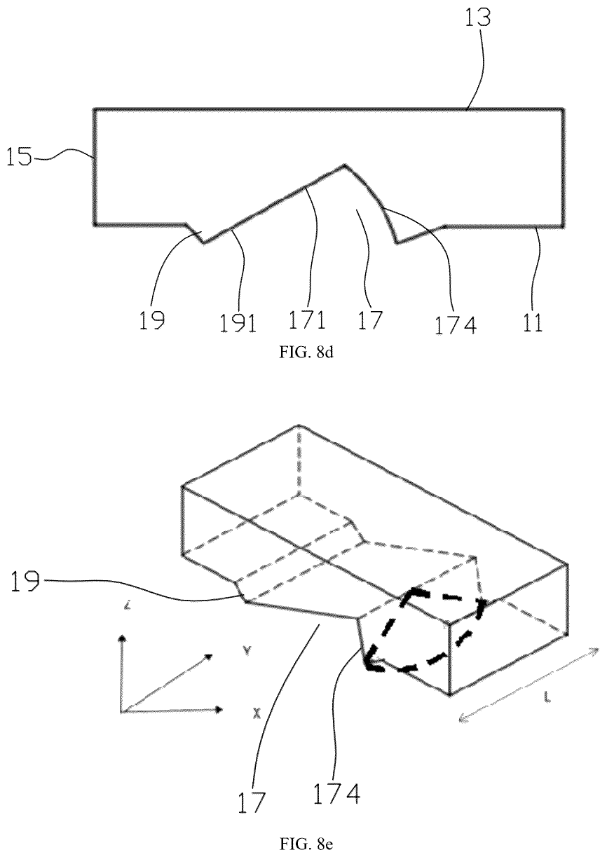

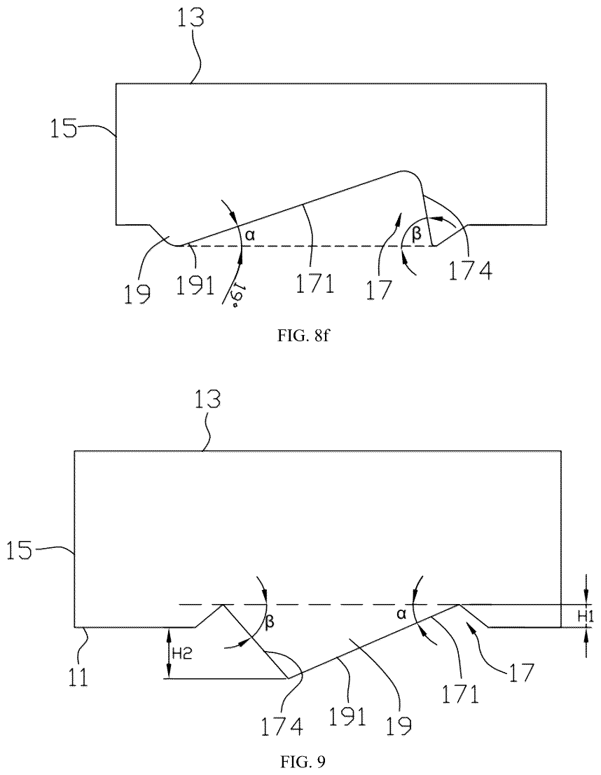

FIGS. 8a and 8b are schematic diagram in a case where section lines of a first surface and a second surface of the microstructure of the light guide plate in FIG. 1 are arcs.

FIGS. 8c and 8d are schematic diagram in a case where the section lines of the first surface and the second surface of the microstructure of the light guide plate in FIG. 1 are arcs.

FIG. 8e is a structural view in a case where a third surface of the microstructure of the light guide plate in FIG. 1 comprises a conical surface.

FIG. 8f is a structural view of a joint between the first surface and the third surface and arc transition of the vertex of a protruding part of the microstructure of the light guide plate in FIG. 1.

FIG. 9 is another partial structural view of the light guide plate in FIG. 1.

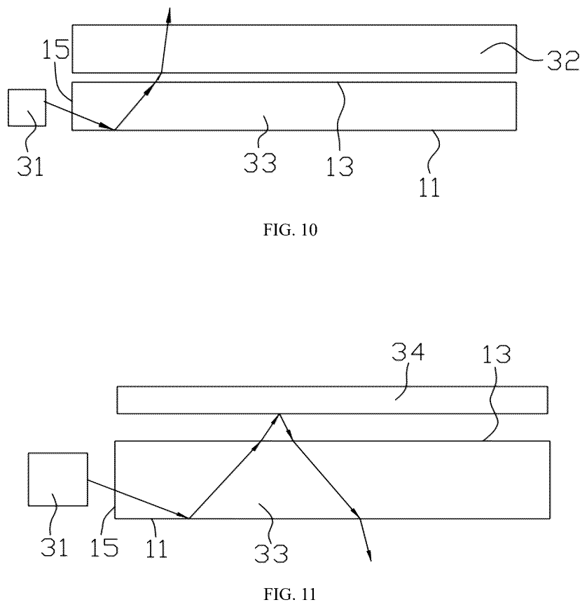

FIG. 10 is a structural view of a display assembly according to Embodiment 2 of the invention.

FIG. 11 is a structural view of a display assembly according to Embodiment 3 of the invention.

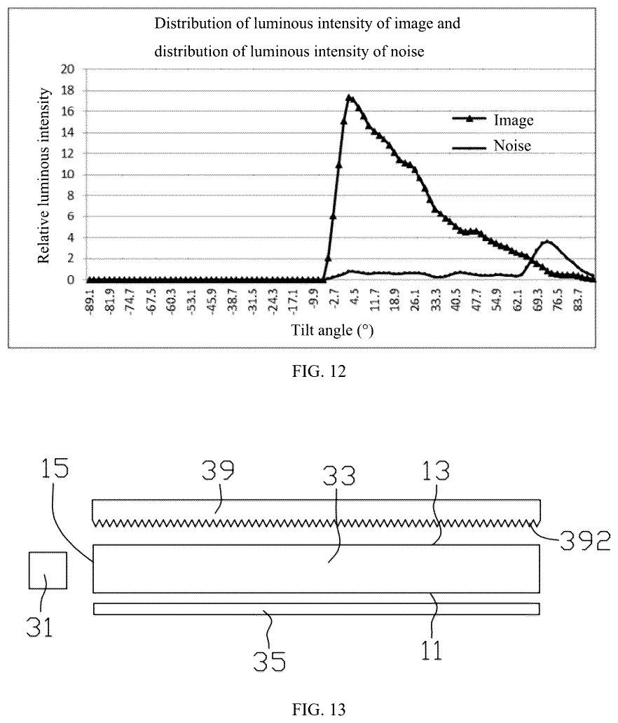

FIG. 12 is a schematic diagram of the relation between an image and a viewing angle and the relation between noise and the viewing angle α ccording to Embodiment 3.

FIG. 13 is a structural view of a backlight unit according to Embodiment 4 of the invention.

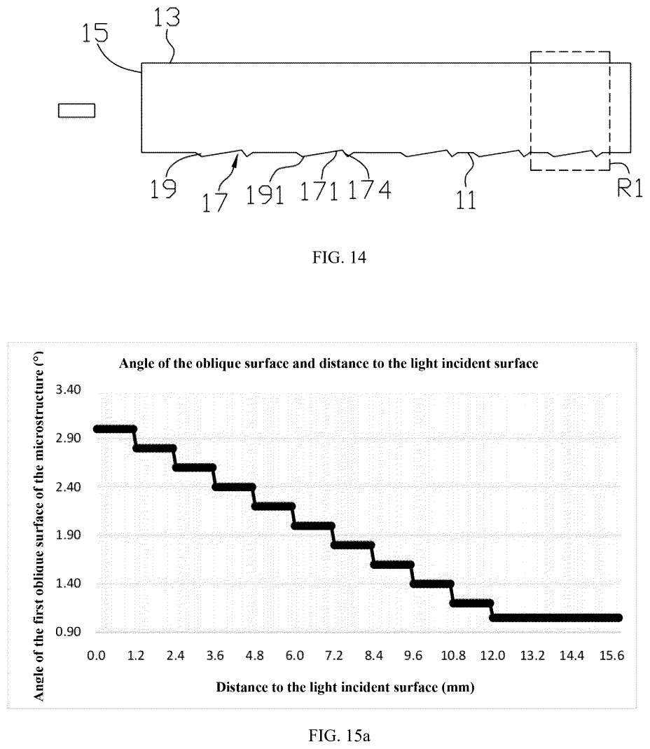

FIG. 14 is a structural view of a light guide plate of the backlight unit in FIG. 13.

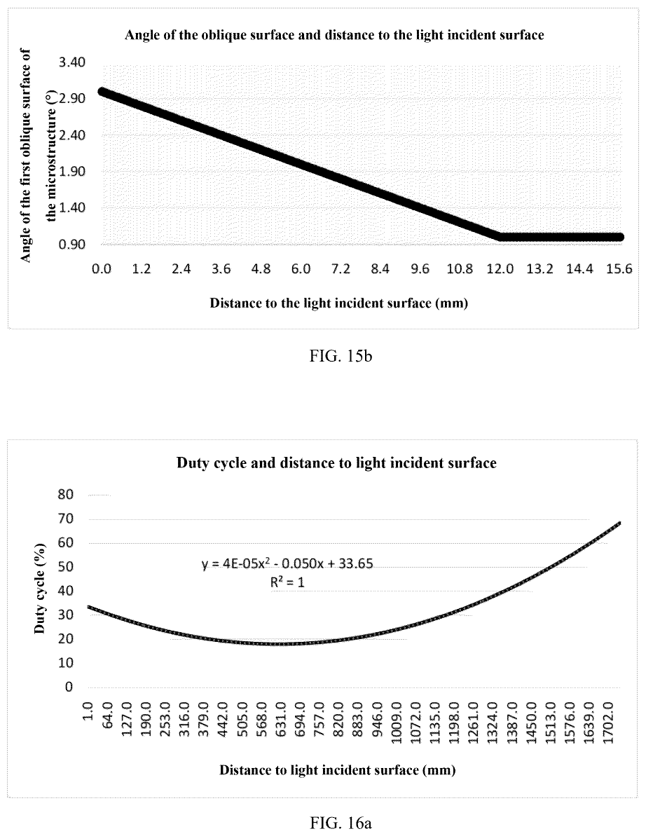

FIG. 15a illustrates a relation between a tilt angle α of the reflecting surface of the microstructures in FIG. 14 and the distance from a microstructure to a light incident surface.

FIG. 15b illustrates another relation between the tilt angle α of the reflecting surface of the microstructure in FIG. 14 and the distance from the microstructure to the light incident surface.

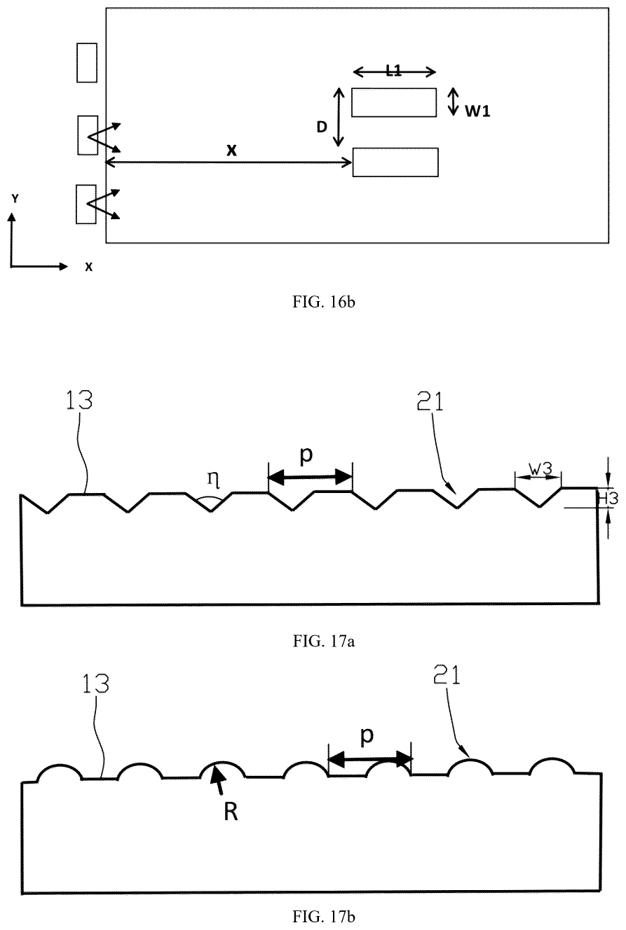

FIG. 16a illustrates a relation between the duty cycle of the microstructure of the light guide plate in FIG. 14 and the distance from the microstructure to the light incident surface 15.

FIG. 16b explains the duty cycle in FIG. 16a.

FIG. 17a is a structural view of lenticular lens structures in one shape of the light guide plate in FIG. 14.

FIG. 17b is a structural view of lenticular lens structures in another shape of the light guide plate in FIG. 14.

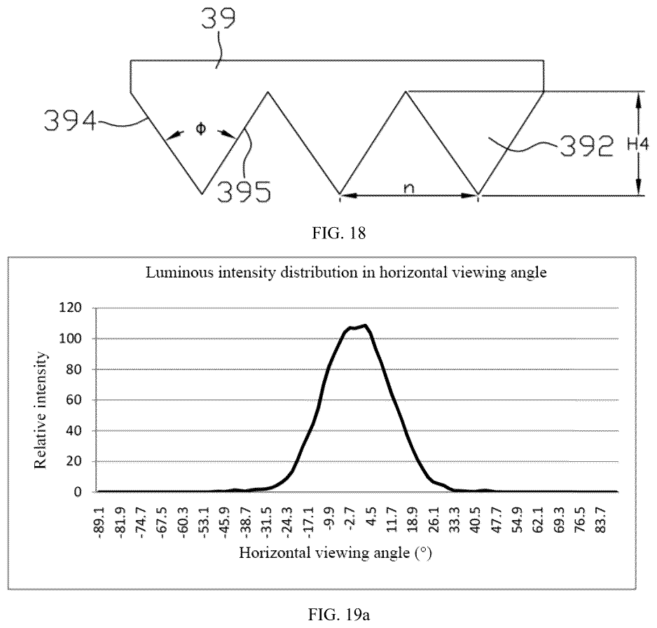

FIG. 18 is a structural view of a microprism structure of a turning film of the backlight unit in FIG. 13.

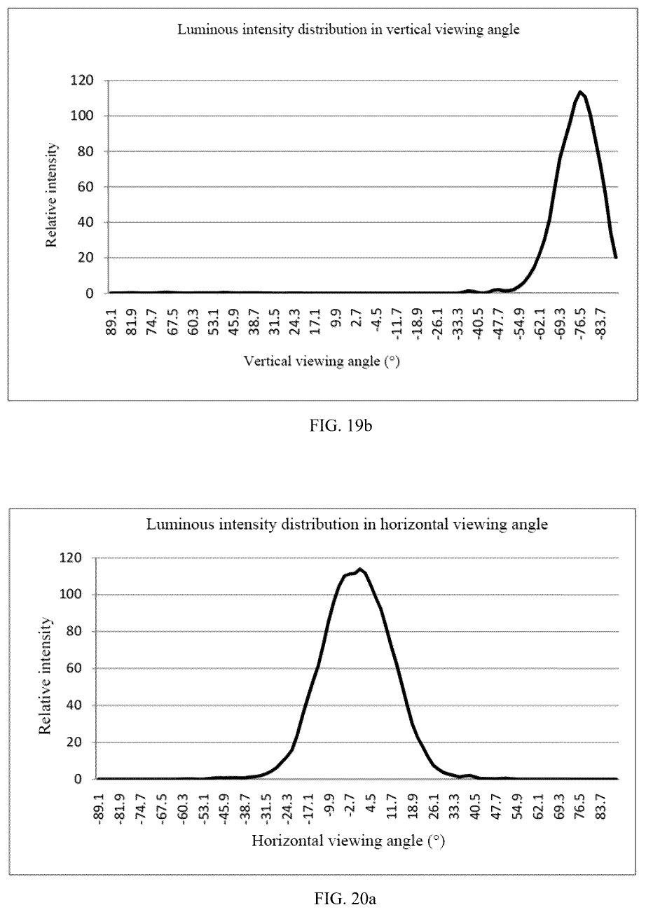

FIGS. 19a and 19b are respectively a distribution graph of the luminous intensity of the light guide plate in FIG. 14 in a horizontal direction and a distribution graph of the luminous intensity of the light guide plate in FIG. 14 in a vertical direction.

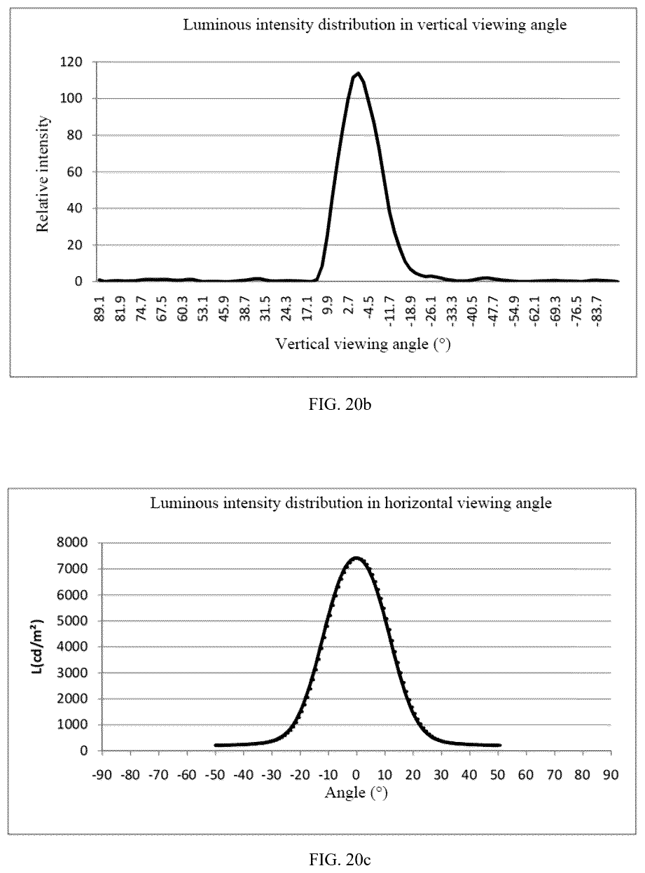

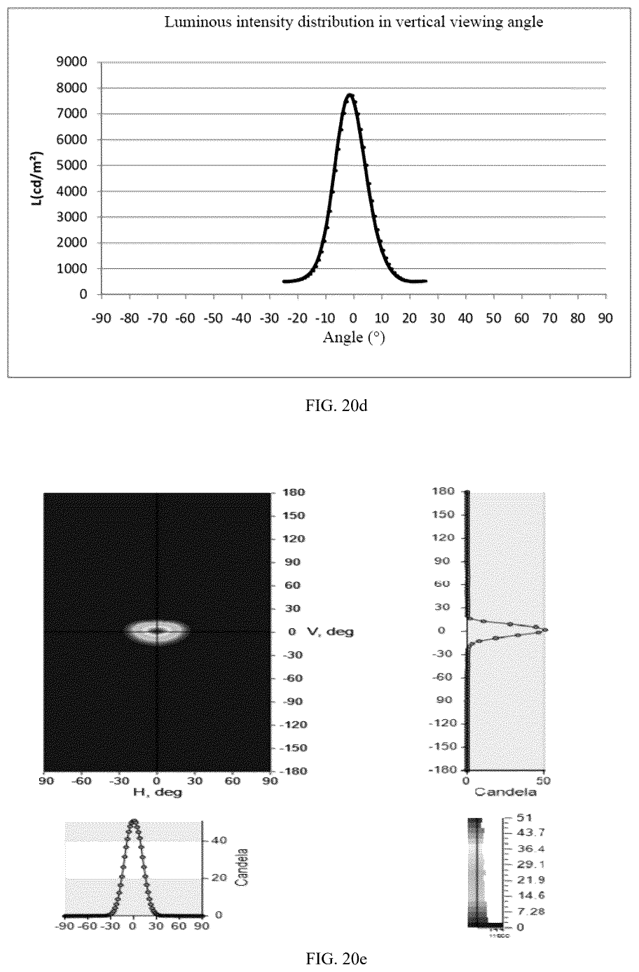

FIGS. 20a and 20b are respectively a distribution graph of the relative luminous intensity of the backlight unit in FIG. 13 in a horizontal direction and a distribution graph of the relative luminous intensity of the backlight unit in FIG. 13 in a vertical direction according to one embodiment.

FIGS. 20c and 20d are respectively a distribution graph of the luminous intensity of the backlight unit in FIG. 13 in a horizontal direction and a distribution graph of the backlight unit in FIG. 13 in a vertical direction according to one embodiment.

FIG. 20e is a graph of the simulated distribution of the luminous intensity of the backlight unit in FIG. 13 in a horizontal direction and a vertical direction according to one embodiment.

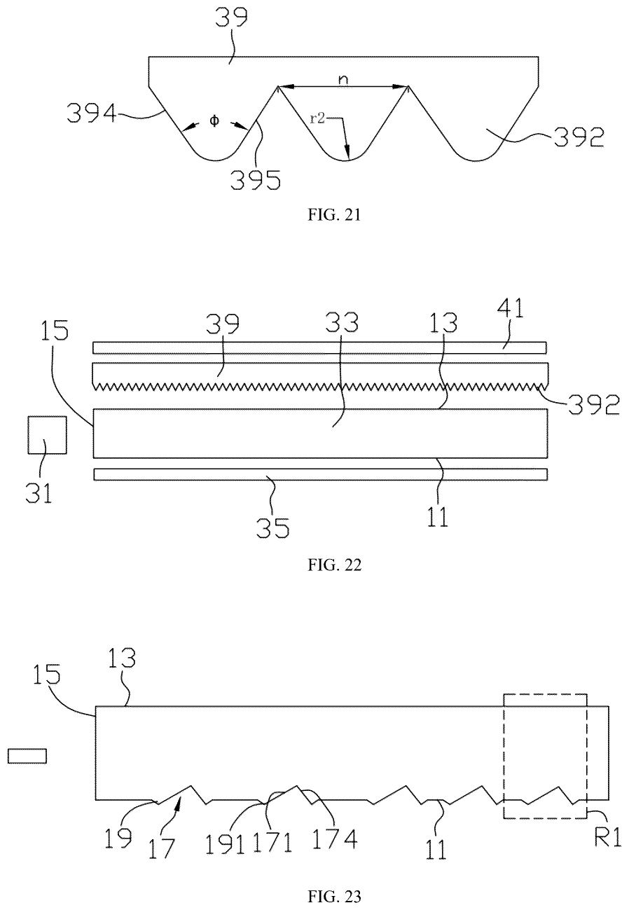

FIG. 21 is another structural view of the microprism structure of the turning film of the backlight unit in FIG. 13.

FIG. 22 is a structural view of a backlight unit according to Embodiment 5 of the invention.

FIG. 23 is a structural view of a light guide plate of the backlight unit in FIG. 22.

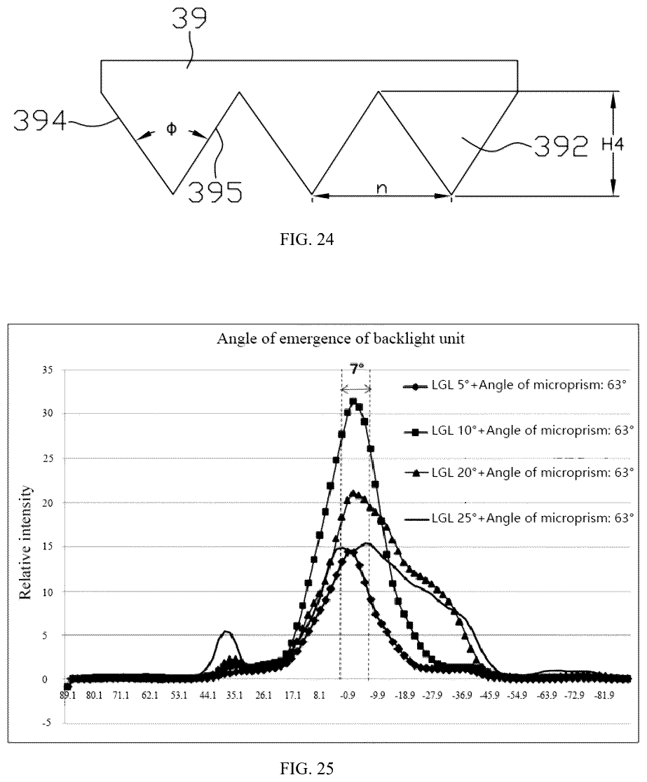

FIG. 24 is a structural view of a microprism structure of a turning film of the backlight unit in FIG. 22.

FIG. 25 is a distribution graph of the luminous intensity of the backlight unit in case of different tilt angles of the reflecting surface of microstructures of light guide plate in FIG. 22 when the vertex angle of the microprism structure of the turning film in FIG. 24 is 63°.

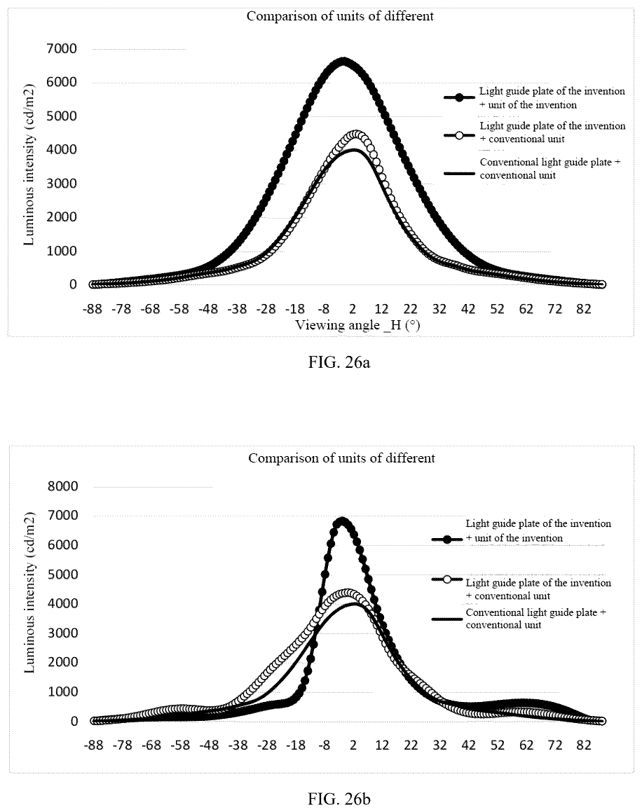

FIGS. 26a and 26b are comparison charts of luminous intensity distributions of backlight units of different structures in a horizontal direction and a vertical direction.

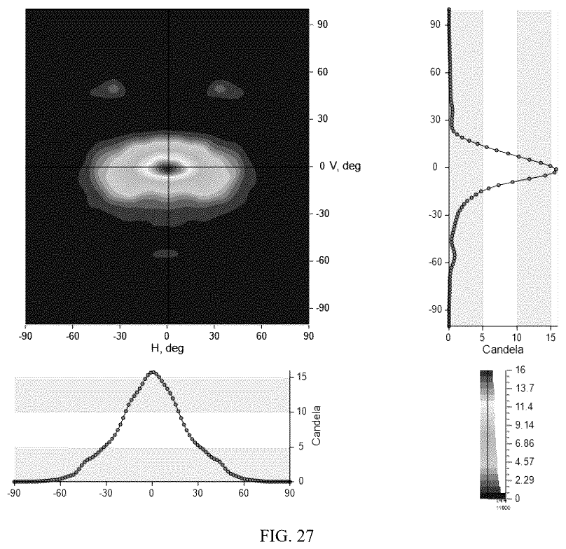

FIG. 27 is a distribution graph of luminous intensity of the backlight unit in FIG. 22 according to one embodiment.

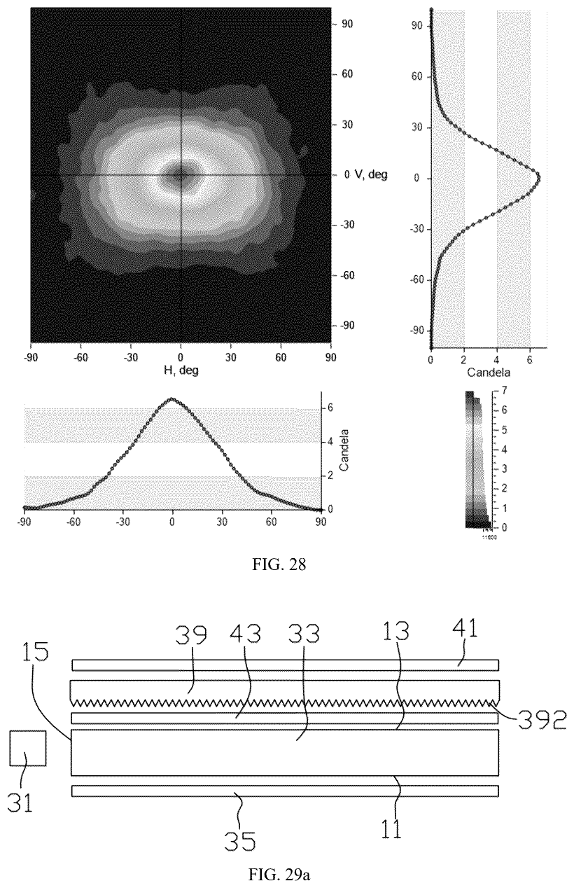

FIG. 28 is a distribution graph of luminous intensity of the backlight unit in FIG. 22 according to another embodiment.

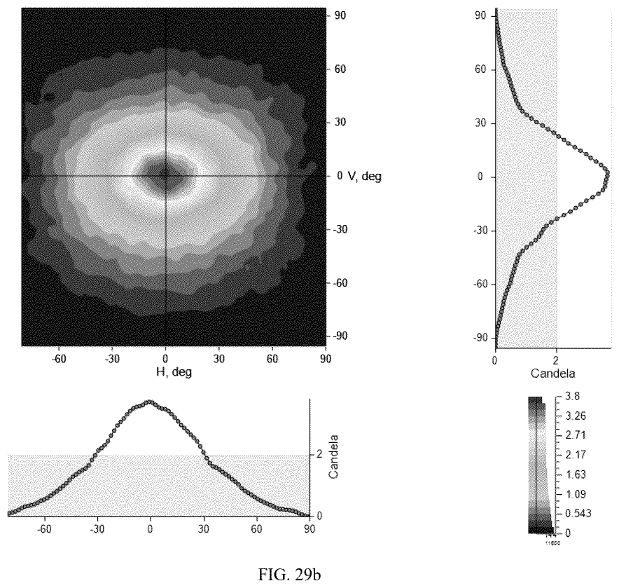

FIG. 29 is another structural view of the backlight unit according to Embodiment 5.

FIG. 29 is a distribution graph of luminous intensity of the backlight unit in FIG. 29a according to one embodiment.

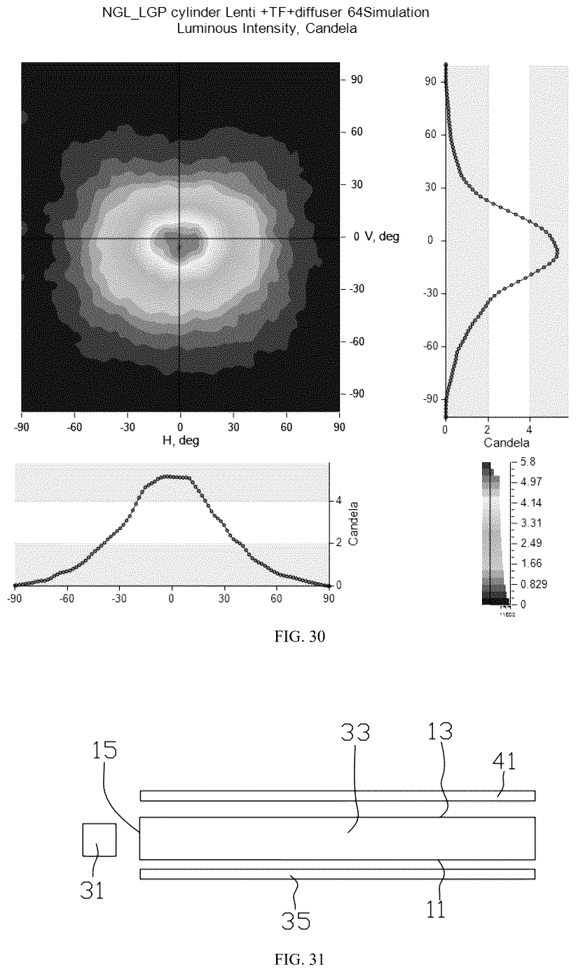

FIG. 30 is a distribution graph of luminous intensity in a case where a filleted corner is formed at a joint between a fourth surface and a fifth surface of the microprism structure of the turning film of the backlight unit in FIG. 22.

FIG. 31 is a structural view of a backlight unit according to Embodiment 6 of the invention.

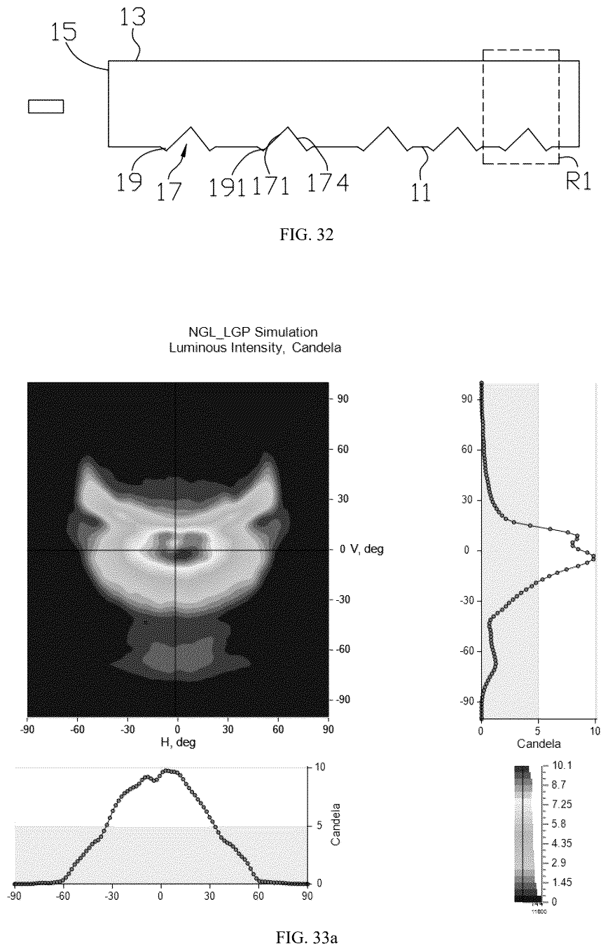

FIG. 32 is a structural view of a light guide plate of the backlight unit in FIG. 31.

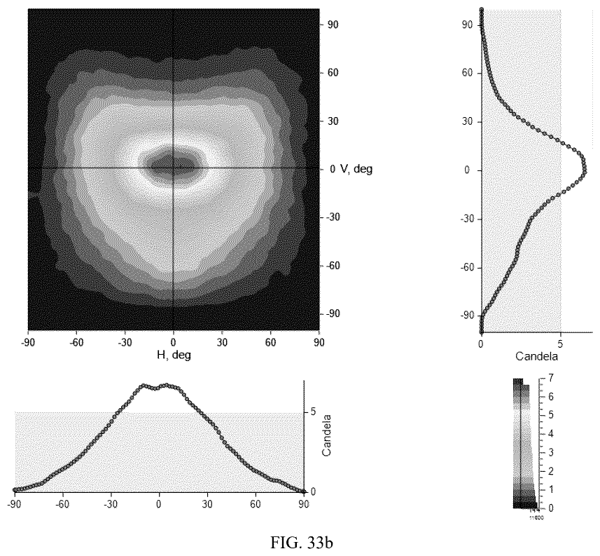

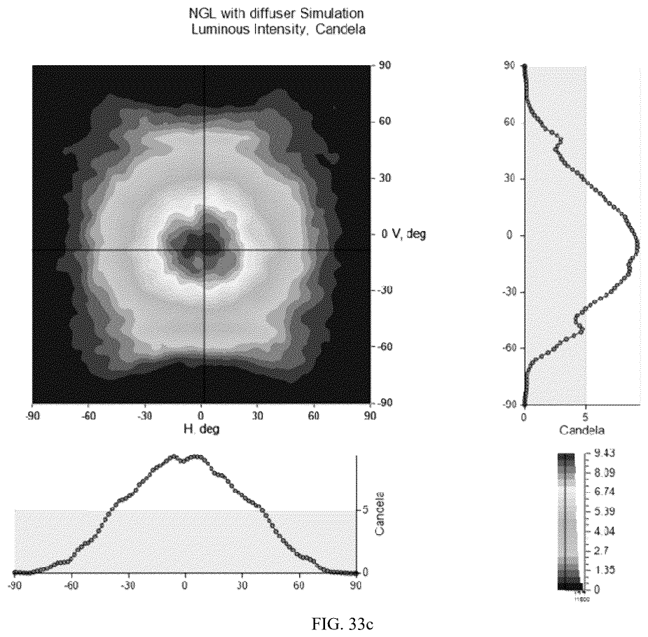

FIG. 33a is a distribution graph of luminous intensity of the light guide plate in FIG. 32.

FIG. 33b is a distribution graph of luminous intensity of the backlight unit in FIG. 31 according to one embodiment.

FIG. 33c is a distribution graph of luminous intensity of the backlight unit in FIG. 31 according to another embodiment.

### DETAILED DESCRIPTION

To further expound the technical means adopted by the invention to fulfill desired purposes and effects of the invention, specific implementations, structures, features and effects of a display panel and a light guide plate provided by the invention are described in detail below in conjunction with accompanying drawings and preferred embodiments.

### Embodiment 1

FIG. 1 is a structural view of a light guide plate according to Embodiment 1 of the invention. The light guide plate in this embodiment may be applied to a backlight side of a transmissive liquid crystal display panel and may also be applied to a light exit side of a reflective liquid crystal display panel. As shown in FIG. 1, the light guide plate comprises a bottom surface 11, a light exit surface 13 and a light incident surface 15, wherein the bottom surface 11 and the light exit surface 13 are arranged opposite to each other, and the light incident surface 15 connects the bottom surface 11 and the light exit surface 13. A plurality of microstructures are formed on the bottom surface 11. The microstructure comprises a concave part 17 and a protruding part 19, wherein the protruding part 19 protrudes towards a side facing away from the light exit surface 13, and the concave part 17 caves in towards the light exit surface 13. The concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171 (that is, the first surface 171 and the second surface 191 are located in a same plane). It can be understood that the microstructures are dotted microstructures and may be distributed on the bottom surface 11 irregularly or distributed on the bottom surface 11 regularly in a matrix.

In this embodiment, referring to FIGS. 1-3, the first surface 171 is a planar surface, that is to say, section lines, in a reference plane R1 perpendicular to the light incident surface 15 and the light exit surface 13, of the first surface 171 and the second surface 191 form a first straight line, and an included angle α between the first straight line and the bottom surface 11 is 0.5°-55°. Specifically, the first surface 171 may be in the shape of a rectangle, a trapezoid, a combination of a trapezoid and a circle, a combination of a rectangle and a circle, a combination of two circles, or the like.

In this embodiment, a depth H1 of the concave part 17 of the microstructure 17 is 0.5 μm-20 μm, a height H2 of the protruding part 19 is 0.2 μm-3 μm, and the ratio of the depth H1 of the concave part 17 to the height H2 of the protruding part 19 of the microstructure is 4-12. A length L1 of the microstructure is 10 μm-150 μm, and a first width W1 of the microstructure is 10 μm-150 μm, wherein the length refers to a size of the microstructure in a direction perpendicular to the light incident surface 15, and the first width refers to a size of the microstructure in a direction parallel to the light incident surface 15 and the light exit surface 13.

Specifically, when the included angle α between the first straight line and the bottom surface 11 or between a tangent of an arc and the bottom surface 11 is 0.5°-5°, the depth H1 of the concave part 17 of the microstructure is 0.5 μm-8 μm, the height H2 of the protruding part 19 is 0.2 μm-1 μm, the ratio of the depth H1 of the concave part 17 to the height H2 of the protruding part 19 of the microstructure is 4-12, the length L1 of the microstructure is 50 μm-150 μm, and the first width W1 of the microstructure is 10 μm-120 μm; when the included angle α between the first straight line and the bottom surface 11 or between the tangent of the arc and the bottom surface 11 is 5°-35°, the depth H1 of the concave part 17 of the microstructure is 2 μm-15 μm, the height H2 of the protruding part 19 is 0.3 μm-3 μm, the ratio of the depth H1 of the concave part 17 to the height H2 of the protruding part 19 of the microstructure is 4-12, the length L1 of the microstructure is 10 μm-100 μm, and the first width W1 of the microstructure is 15 μm-150 μm; when the included angle α between the first straight line and the bottom surface 11 or between the tangent of the arc and the bottom surface 11 is 35°-55°, the depth H1 of the concave part 17 of the microstructure is 4 μm-20 μm, the height H2 of the protruding part 19 is 0.2 μm-3 μm, the ratio of the depth H1 of the concave part 17 to the height H2 of the protruding part 19 of the microstructure is 4-12, the length L1 of the microstructure is 10 μm-80 μm, and the first width W1 of the microstructure is 15 μm-150 μm. Wherein, the length refers to a size of the microstructure in a direction perpendicular to the light incident surface 15, and the first width refers to a size of the microstructure in a direction perpendicular to the light incident surface 15 and the light exit surface 13.

In some embodiments, when the included angle α between the first straight line and the bottom surface 11 or between the tangent of the arc and the bottom surface 11 is 30°-50°, the depth H1 of the concave part 17 of the microstructure is 2 μm-15 μm, the height H2 of the protruding part 19 is 0.1 μm-3 μm, the ratio of the depth H1 of the concave part 17 to the height H2 of the protruding part of the microstructure is 4-12, the length L1 of the microstructure is 10 μm-60 μm, and the first width W1 of the microstructure is 10 μm-60 μm.

In this embodiment, the microstructure further comprises a third surface 174, the first surface 171 is connected to the third structure 174, and one part of the third surface 174 and the first surface 171 are two sides of the concave part 17 respectively.

Specifically, a section line, in the reference plane R1 perpendicular to the light incident surface 15 and the light exit surface 13, of the third surface 174 is a second straight line, and an included angle between the second straight line and the bottom surface 11 is 40°-80°. Herein, the first straight line and the second straight line are merely for distinguishing section lines of different surfaces and do not refer to specific straight lines.

Specifically, a section line, in a reference plane parallel to the bottom surface 11, of the third surface 174 is a straight line.

Specifically, the section lines, in the reference plane R1 perpendicular to the light incident surface and the light exit surface, of the first surface 171 and the third surface 174 form a sharp corner at a joint between the first surface 171 and the third surface 174, and a sharp corner is formed at a vertex of the protruding part 19.

In this embodiment, the concave part 17 of the microstructure is prismatic, wherein two adjacent sides of a microprism form the first surface 171 and the third surface 174 of the concave part 17 respectively, and the section lines, in the reference plane R1 perpendicular to the light incident surface and the light exit surface, of the first surface 171 and the third surface 174 form a sharp corner at a joint between the first surface 171 and the third surface 174. Specifically, in this embodiment, the concave part 17 is a triangular prism.

It can be understood that the concave part 17 may be in other shapes. In other embodiments, as shown in FIG. 4a, the concave part 17 may be in the shape of a truncated cone formed by partially cutting away the top and one side of a cone, a top surface of the truncated cone inclines with respect to an axis of the truncated cone and intersects with a bottom surface of the truncated cone at a point, the bottom surface of the truncated cone is perpendicular to the axis of the truncated cone, and the top surface forms the first surface 171; as shown in FIG. 4b, the concave part 17 may be in the shape of a truncated cone formed by partially cutting away the top and one side of a cone, a top surface of the truncated cone inclines with respect to an axis of the truncated cone and intersects with a bottom surface of the truncated cone along a straight line, the bottom surface of the truncated cone is perpendicular to the axis of the truncated cone, and the top surface forms the first surface 171; as shown in FIG. 4c, the concave part 17 may be in the shape of a semicylinder formed by partially cutting away the top and one side of a cylinder, a top surface of the semicylinder inclines with respect to an axis of the semicylinder and intersects with a bottom surface of the semicylinder at a point, and the top surface forms the first surface; as shown in FIG. 4d, the concave part 17 may be in the shape of a cylinder, a top surface of the cylinder inclines with respect to an axis of the cylinder and intersects with a bottom surface of the cylinder at a point, and the top surface forms the first surface 171; as shown in FIG. 4e, the concave part 17 may be in the shape of a cylinder formed by partially cutting away the top and one side of a cylinder, a top surface of the semicylinder inclines with respect to an axis of the semicylinder and intersects with a bottom surface of the semicylinder along a straight line, and the top surface forms the first surface 171. In these examples of the concave part, the bottom surface of the truncated cone or the bottom surface of the semicylinder may be located in a same plane as the bottom surface 11 of the light guide plate, and the top surface may also form the second surface 191.

As shown in FIG. 4f, the concave part 17 may be in the shape of a hemispheroid formed by partially cutting away a dome of a spheroid from two different angles, a top surface formed by partially cutting away the dome of the spheroid from one angle inclines with respect to a bottom surface of the hemispheroid, and the top surface of the hemispheroid forms the first surface 171; as shown in FIG. 4g, the concave part 17 may be a hemispheroid formed by partially cutting away a dome of a spheroid, a top surface formed by partially cutting away the dome of the spheroid inclines with respect to a bottom surface of the hemispheroid, and the top surface of the hemispheroid forms the first surface 171. In these examples of the concave part, the bottom surface of the hemispheroid may be located in a same plane as the bottom surface 11 of the light guide plate, and the top surface may also form the second surface 191.

According to the light guide plate with the microstructures, when light enters the light guide plate from the light incident surface 15 of the light guide plate, the luminous intensity distribution of light exiting from the light exit surface 13 of the light guide plate has a specific intensity peak angle. As for the light guide plate shown in FIG. 1, in a case where α=10°, W1=20 μm, L1=20 μm, the light guide plate is made from polymethyl methacrylate (PMMA) and the thickness of the light guide plate is T=0.5 mm, the luminous intensity distribution of the light guide plate is shown in FIG. 5a. It can be known from FIG. 5a that the peak viewing angle ω in a vertical direction is 65°, the full width at half maximum (FWHM) is 23.8°, wherein the vertical direction is a direction perpendicular to the light incident surface, and a horizontal direction is a direction parallel to the light incident surface. The luminous intensity distribution of a conventional light guide plate is shown in FIG. 5a. It can be seen that compared with the conventional light guide plate, the peak luminous intensity angle of the light guide plate in this embodiment is closer to a normal direction of the light exit surface of the light guide plate, and the FWHM is smaller, such that the luminous intensity can be adjusted towards the axial viewing angle more easily.

FIG. 5c and FIG. 5d respectively illustrate the luminous intensity distribution of the light guide plate in FIG. 1 in case of tilt angles α of reflecting surfaces of different microstructures and the luminous intensity distribution of a conventional light guide plate in a horizontal viewing angle, and a graph of the luminous intensity distribution of the light guide plate in FIG. 1 in case of different tilt angles and the luminous intensity distribution of the conventional light guide plate in a vertical viewing angle.

Referring to FIG. 5e which illustrate the relation between the tilt angle α of a reflecting surface of the microstructure of the light guide plate, an emission angle of a light source and reflection times, when α>9°, light within the emission angle of 0-22° of the light source can exit from the light guide plate after being reflected twice by the reflecting surface 2, and when the emission angle is greater than 22°, light can exit from the light guide plate after being reflected once only. It thus can be seen that by controlling the tilt angle α, the reflection times of light in the light guide plate and the angles of emergence ω1 and ω2 can be controlled; and by controlling the tilt angle α, the full width of the angle of emergence ω (a difference between ω1 and ω2) can also be controlled.

Referring to FIGS. 5f-5g, as for the microstructure shown in FIG. 3, the first surface 171 and the second surface 191 are both planar surfaces. A projection of the first surface 171 and the third surface 174 in an XY plane is A′B′C′D′ in FIG. 5f, and a projection of the first surface 171 and the third surface 174 in a YZ plane is B′E′F′C′ in FIG. 5g. As for the microstructure, the first surface and the third surface are arc surfaces, shown in FIG. 6a (in this microstructure, a section line, in a reference plane parallel to the light incident surface 15, of a reflecting surface ADE and a section line, in a reference plane parallel to the bottom surface 11, of the reflecting surface ADE are both arcs), a projection of the reflecting surface ADE in the XY plane is shown in FIG. 6b, and a projection of the reflecting surface ADE in the YZ plane is shown in FIG. 6c. It thus can be seen that under the same length L1, width W1 and depth H1, the microstructure in FIG. 4 has a larger effective reflecting area. Therefore, when both the first surface 171 and the third surface 191 are planar surfaces, the microstructure has a larger effective reflecting area under the same length L1, width W1 and depth H1, and the luminous intensity of the light guide plate can be better improved.

Referring to FIG. 6d and FIG. 6e, a viewing angle T1 of reflected light in the horizontal direction of the microstructure shown in FIG. 3 is far smaller than T2 of the microstructure shown in FIG. 6a, indicating that the microstructure shown in FIG. 3 is more beneficial to light concentration. Therefore, the light guide microstructure shown in FIG. 3 has a small viewing angle and is more beneficial to light concentration, thus increasing the on-axis luminous density of the light guide plate and improving the brightness of the light guide plate.

Referring to FIG. 7a which is a comparison chart of the average luminous intensity in case of different tilt angles α of the microstructure on the light guide plate in FIG. 1 and the average luminous intensity of the conventional light guide plate, it can be seen that the tilt angle α of the reflecting surface of the microstructure has an influence on the average luminous intensity of the light guide plate, and compared with the conventional light guide plate (the average luminous intensity of which is 6520 lux), when the tilt angle is 7.5°<α<55°, the average luminous intensity of the light guide plate in this embodiment is greater than the average luminous intensity of the conventional circular dots, indicating that the microstructure in this embodiment has higher light use efficiency and better light guide performance. Referring to FIG. 7b which is a comparison chart of the peak luminous intensity in case of different tilt angles α of the microstructure on the light guide plate in FIG. 1 and the peak luminous intensity of the conventional light guide plate, it can be seen that the tilt angle α of the microstructure has an influence on the peak luminous intensity, and compared with the conventional light guide plate (the peak luminous intensity of which is 10.87 cd), when the tilt angle is 7.5°<α<35°, the peak luminous intensity of the microstructure is greater than the peak luminous intensity of the conventional circular dots, that is, the microstructure in this embodiment has higher light use efficiency and better light guide performance. When average luminous intensity is taken into account, the tilt angle α is preferably 12.5°-37.5°, further preferably 15°-30°; and when the peak luminous intensity is also taken into account, the tilt angle α is preferably 7.5°-32.5°, further preferably 10°-27.5°.

Referring to FIG. 7c which is a curve chart of the FWHM of the luminous intensity in case of different tilt angles α, it can be seen that the tilt angle α of the oblique surface of the microstructure is related to some extent to the distribution of the FWHM of the luminous intensity and is approximately in linear relation with the distribution of the FWHM of the luminous intensity in the vertical direction, indicating the intensity peak angle @ of the light guide plate can be controlled by controlling the tilt angle α of the microstructure. In addition, the FWHM of the luminous intensity of the light guide plate can be controlled by controlling the tilt angle α, so as to change the degree of concentration of the luminous intensity of the light guide plate to adapt to different application fields. For example, when 0.5°<α<5°, the FWHM in the vertical direction is less than 25°, and the light guide plate can be applied to special application scenarios requiring a small viewing angle, such as a privacy light guide plate; when 5°<α<35°, the FWHM in the vertical direction is 25°-64°, and the light guide plate can be applied to special application scenarios requiring a medium viewing angle, such as a laptop; and when α>35°, the FWHM in the vertical direction is greater than 60°, and the light guide plate can be applied to display scenarios requiring a large viewing angle, such as a TV.

According to the light guide plate in this embodiment, the microstructures comprising the concave parts and the protruding parts are formed on the bottom surface of the light guide plate, and the first surfaces and the second surfaces are used together to enlarge the area of an effective reflecting surface, thus improving the light coupling efficiency; the protruding parts can prevent adsorption between the light guide plate and other films and top whitening phenomenon; when the light guide plate is applied to a transmissive liquid crystal backlight unit, a brightness enhancement film can be omitted, thereby reducing film layers of the backlight unit, simplifying the structure and assembly process, and improving the light use efficiency; and when the light guide plate is applied to a reflective liquid crystal front-light unit, the beam splitting ratio and light use efficiency within the axial viewing angle can be improved.

It can be understood that, referring to FIGS. 8a and 8b, the section lines of the first surface 171 and the second surface 191 in the reference plane R1 may form a first arc, and an included angle between a tangent of the first arc and the bottom surface 11 is a 0.5°-55°. It can be understood that the section lines of the first surface 171 and the second surface 191 in the reference plane R1 may be a straight line and an arc (comprises a straight line and an arc), and an included angle α between the straight line and the bottom surface and between a tangent of the arc and the bottom surface is 0.5°-55°.

It can be understood that, referring to FIG. 8c and FIG. 8d, the section line, in the reference plane R1 perpendicular to the light incident surface 15 and the light exit surface 13, of the third surface 174 may be a second arc, and an included angle between a tangent of the second arc and the bottom surface 11 is 40°-80°. It can be understood that the section line, in the reference plane R1 perpendicular to the light incident surface 15 and the light exit surface 13, of the third surface 174 may be a broken line, and an included angle between the broken line and the bottom surface 11 is 40°-80°. Referring to FIG. 8e, at least part of the third surface 171 is a conical surface, and at least part of a section line, in a reference plane parallel to the bottom surface 11, of the third surface 174 is an arc. Here, the first arc and the second arc are merely for distinguishing section lines of different surfaces and do not refer to specific arcs.

It can be understood that, referring to FIG. 8f, the section lines, in the reference plane R1 perpendicular to the light incident surface and the light exit surface, of the first surface 171 and the third surface 174 are in arc transition, and arc transition is formed at the vertex of the protruding part 19.

In another embodiment, the microstructure of the light guide plate is different from the microstructure of the light guide plate in the embodiment shown in FIG. 1. In this embodiment, referring to FIG. 9, the microstructure comprises a concave part 17 and a protruding part 19, wherein the protruding part 19 protrudes towards a side facing away from the light exit surface 13, and the concave part 17 caves in towards the light exit surface 13. The concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171 (that is to say, the first surface 171 and the second surface 191 are located in a same plane). The microstructure further comprises a third surface 174, the second surface 191 is connected to the third surface 174, and one part of the third surface 174 and the second surface 191 are two sides of the protruding part 19 respectively.

Specifically, in this embodiment, the depth H1 of the concave part 17 of the microstructure is 0.2 μm-3 μm, the height H2 of the protruding part 19 is 0.5 μm-20 μm, the ratio of the depth H1 of the concave part 17 to the height H2 of the protruding part 19 of the microstructure is 1/12-¼, the length L1 of the microstructure is 50 μm-150 μm, and the first width W1 of the microstructure 10 μm-120 μm. Wherein, when the included angle α between the first straight line and the bottom surface 11 or between the tangent of the arc and the bottom surface 11 is 0.5°-5°, the depth H1 of the concave part 17 of the microstructure is 0.2 μm-1 μm, the height H2 of the protruding part 19 is 0.5 μm-8 μm, and the ratio of the depth H1 of the concave part 17 to the height H2 of the protruding part 19 of the microstructure is 1/12-¼; when the included angle α between the first straight line and the bottom surface 11 or between the tangent of the arc and the bottom surface 11 is 5°-35°, the depth H1 of the concave part 17 of the microstructure is 0.3 μm-3 μm, the height H2 of the protruding part 19 is 2 μm-15 μm, and the ratio of the depth H1 of the concave part 17 to the height H2 of the protruding part 19 of the microstructure is 1/12-¼; when the included angle α between the first straight line and the bottom surface 11 or between the tangent of the arc and the bottom surface 11 is 35°-55°, the depth H1 of the concave part 17 of the microstructure is 0.2 μm-3 μm, the height H2 of the protruding part 19 is 4 μm-20 μm, and the ratio of the depth H1 of the concave part 17 to the height H2 of the protruding part 19 of the microstructure is 1/12-¼. In some embodiments, when the included angle α between the first straight line and the bottom surface 11 or between the tangent of the arc and the bottom surface 11 is 30°-50°, the depth H1 of the concave part 17 of the microstructure is 0.1 μm-3 μm, the height H2 of the protruding part 19 is 2 μm-15 μm, and the ratio of the depth H1 of the concave part 17 to the height H2 of the protruding part 19 of the microstructure is 1/12-¼, the length L1 of the microstructure is 10 μm-60 μm, and the first width W1 of the microstructure 10 μm-60 μm.

### Embodiment 2

The invention further provides a display assembly applied to a transmissive liquid crystal display panel. Referring to FIG. 10, in one embodiment, the display assembly comprises a light source 31, a light guide plate 33 and a transmissive liquid crystal display panel 32, wherein the light guide plate 33 is the light guide plate in Embodiment 1, the light source 31 is arranged on one side of the light incident surface 15 of the light guide plate 33, and the light guide plate 33 is located on a backlight side of the transmissive liquid crystal display panel 32.

Specifically, the transmissive liquid crystal display panel 32 is arranged on one side of the light exit surface 13 of the light guide plate 33, and the backlight side of the transmissive liquid crystal display panel 32 is arranged opposite to the light exit surface 13 of the light guide plate 33. When the display assembly is assembled, the light exit surface 13 is closed to the backlight side of the transmissive liquid crystal display panel 32, such that light exiting from the light exit surface 13 enters the backlight side of the transmissive liquid crystal display panel 32. Further, an adhesive layer or an air layer may be arranged between the transmissive liquid crystal display panel 32 and the light guide plate 33.

According to the display assembly in this embodiment, after light enters the light guide plate 33 and exits from the light exit surface 13 of the light guide plate 33, the light enters the transmissive liquid crystal display panel 32 from the backlight side of the transmissive liquid crystal display panel 32 and is then transmitted by the transmissive liquid crystal display panel 32 to a light receiver or a human observer corresponding to the transmissive liquid crystal display panel 32.

### Embodiment 3

The inventio further provides a display assembly applied to a reflective liquid crystal display panel. Referring to FIG. 11, in one embodiment, the display assembly comprises a light source 31, a light guide plate 33 and a reflective liquid crystal display panel 34, wherein the light guide plate 33 is the light guide plate in Embodiment 1, the light source 31 is arranged on one side of the light incident surface 15 of the light guide plate 33, and the light guide plate 33 is located on a light exit side of the reflective liquid crystal display panel 34.

Specifically, the reflective liquid crystal display panel 34 is arranged on one side of the light exit surface 13 of the light guide plate 33, and the light exit side of the reflective liquid crystal display panel 34 is arranged opposite to the light exit surface 13 of the light guide plate 33. When the display assembly is assembled, the light exit surface 13 is closed to the light exit side of the reflective liquid crystal display panel 34, such that light exiting from the light exit surface 13 of the light guide plate 33 is radiated to the light exit side of the reflective liquid crystal display panel 34. Further, an adhesive layer or an air layer may be arranged between the reflective liquid crystal display panel 34 and the light guide plate 33.

According to the display assembly in this embodiment, after light enters the light guide plate 33 and exits from the light exit surface 13 of the light guide plate 33, the light is radiated to the light exit side of the transmissive liquid crystal display panel 34 and is then reflected by the reflective liquid crystal display panel 34 to a light receiver or a human observer corresponding to the reflective liquid crystal display panel 34.

In this embodiment, the included angle between the first straight line and the bottom surface 11 of the light guide plate or between the tangent of the first arc and the bottom surface 11 of the light guide plate is preferably 30°-50°.

According to the display assembly adopting the light guide plate and the reflective liquid crystal display panel, the light propagation angle is adjusted based on the first surfaces and the second surfaces of the light guide plate to make the intensity peak angle of emergence more approximate to the normal direction of the bottom surface, so as to control the angle of an image exiting from the light exit surface within the viewing angle (−5°-25°) of the light guide plate and control the angle of noise reflected by the reflecting surface to be greater than a viewing angle of 50°, such that the ratio of the luminous intensity of the image exiting from the light exit surface to the luminous intensity of the noise on the bottom surface of the light guide plate is greater than 5:1, and the splitting ratio in the axial viewing angle is 20:1, thus remarkably improving the image contrast in the axial viewing angle of the display assembly and improving the light use efficiency. Below, the image contrast and light use efficiency of one specific display assembly are described by way of an example.

The structure of the light guide plate of the display assembly is as shown in FIGS. 1-4, wherein α=40°, β−80°, W1=20 μm, H1=7 μm, H2=2 μm and L1=20 μm. The light guide plate is made from PWMA, and the thickness of the light guide plate is T=0.5 mm. Referring to FIG. 2 which is a schematic diagram of the relation between the luminous intensity of the image of the light guide plate and the viewing angle and the relation between the luminous intensity of the noise of the light guide plate and the viewing angle, the intensity peak angle of the image of the light guide plate is about 0°, and 75% of the luminous intensity of the image is concentrated within the axial viewing angle (−5°-25°); the intensity peak angle of the noise is about 73°, and only 25% of the luminous intensity of the noise is concentrated within the axial viewing angle (−5°-25°); and the splitting ratio is 9.6:1, and the splitting ratio within the axial viewing angle is 22:1, such that splitting ratio within the axial viewing angle of the light guide plate is greatly improved.

### Embodiment 4

The invention further provides a backlight unit, which may be applied to a transmissive liquid crystal display panel. Referring to FIG. 13, the backlight unit in Embodiment 4 comprises a light source 31, a light guide plate 33, a reflector 35 and a turning film 39, wherein the light guide plate 33 comprises a bottom surface 11, a light exit surface 13 and a light incident surface 15, the bottom surface 11 and the light exit surface 33 are arranged opposite to each other, and the light incident surface 15 connects the bottom surface 11 and the light exit surface 13. The light source 31 is arranged on one side of the light incident surface 15 of the light guide plate 33, the reflector 35 and the turning film 39 are arranged on two sides of the light guide plate 33 respectively, the turning film 39 is arranged close to the light exit surface 13 of the light guide plate, and a plurality of microprism structures 392 are arranged on the turning film 39 and protrude towards the light exit surface 13 of the light exit surface 13. Referring to FIG. 14, a plurality of microstructures are arranged on the bottom surface 11 of the light guide plate 33. The microstructure comprises a protruding part 19 and a concave part 17, wherein the protruding part 19 protrudes towards a side facing away from the light exit surface 13, the concave part 17 caves in towards the light exit surface 13, the concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171. A section line, in a reference plane R1 perpendicular to the light incident surface 15 and the light exit surface 13, of the first surface 171 is a first straight line, and an included angle between the first straight line and the bottom surface 11 is 0.5°-5°.

In this embodiment, a depth H1 of the concave part 17 of the microstructure is 0.5 μm-8 μm, a height H2 of the protruding part 19 is 0.2 μm-1 μm, the ratio of the depth H1 of the concave part 17 to the height H2 of the protruding part 19 of the microstructure is 4-12, a length L1 of the microstructure is 50 μm-150 μm, and a first width W1 of the microstructure is 10 μm-120 μm.

In this embodiment, the included angle between the first straight line and the bottom surface 11 or an included angle between a tangent of a first arc and the bottom surface 11 deceases with the increase of a distance from the microstructure to the light incident surface 15.

In this embodiment, the included angle α between the first straight line and the bottom surface 11 decreases with the increase of the distance from the microstructure to the light incident surface 15. Referring to FIG. 15a which illustrates a relation between a tilt angle α and the distance from the microstructure to the light incident surface, the tilt angle α changes in gradient manner. Referring to FIG. 15b which illustrates another relation between the tilt angle α and the distance from the microstructure to the light incident surface, the tilt angle α changes continuously.

Specifically, referring to FIG. 16a, the relation between the duty cycle of the microstructure and the distance from the microstructure to the light incident surface 15 satisfies y=4E−05×2−0.050×+33.65, wherein y is the duty cycle, and x is the distance from the microstructure to the light incident surface. Wherein, referring to FIG. 16b, the duty cycle refers to the quotient obtained by dividing the first width W1 of the microstructure by the sum of the first width W1 of the microstructure and a distance D between the microstructure and an adjacent microstructure in the width direction.

In this embodiment, the concave part 17 of the microstructure further comprises a third surface 174, wherein the first surface 171 is connected to the third surface 174, and one part of the third surface 174 and the first surface 171 are two sides of the concave part 17 respectively.

A section line, in the reference plane R1 perpendicular to the light incident surface 15 and the light exit surface 13, of the third surface 174 is a second straight line, a second arc or a broken line, and an included angle between the second straight line and the bottom surface 11, between a tangent of the second arc and the bottom surface 11, or between the broken line and the bottom surface 11 is 40°-80°.

Specifically, the section line, in the reference plane R1 perpendicular to the light incident surface 15 and the light exit surface 13, of the third surface 174 is a second straight line, and an included angle between the second straight line and the bottom surface 11 is 40°-80°.

Specifically, a section line, in a reference plane parallel to the bottom surface 11, of the third surface 174 is a straight line.

Specifically, the section lines, in the reference plane R1 perpendicular to the light incident surface and the light exit surface, of the first surface 171 and the third surface 174 form a sharp corner at a joint between the first surface 171 and the third surface 174, and a sharp corner is formed at the vertex of the protruding part 19.

In some embodiments, the section lines, in the reference plane R1 perpendicular to the light incident surface and the light exit surface, of the first surface 171 and the third surface 174 are in arc transition; and/or, arc transition is formed at the vertex of the protruding part 19.

In this embodiment, the concave part 17 of the microstructure is prismatic, two adjacent sides of a microprism form the first surface 171 and the third surface 174 of the concave part 17 respectively, and the section lines, in the reference plane R1 perpendicular to the light incident surface and the light exit surface, of the first surface 171 and the third surface 174 form a sharp corner at a joint between the first surface 171 and the third surface 174. Specifically, in this embodiment, the concave part 17 is a triangular prism. It can be understood that the concave part 17 may be in other shapes shown in FIGS. 4a-4g.

In this embodiment, referring to FIG. 17a (the microstructures on the bottom surface are not shown), a plurality of lenticular lens structures (lenti structures) 21 are arranged on the light exit surface 13 of the light guide plate.

Specifically, the lenticular lens structures 21 extend in a direction parallel to the light incident surface 15, a depth H3 of the lenticular lens structures 21 is 3 μm-20 μm, and a second width W3 of the lenticular lens structures 21 is 10 μm-60 μm. Wherein, the depth H3 is a size of the lenticular lens structures 21 in a direction perpendicular to the light exit surface 13, and the second width W3 is a size of the lenticular lens structures 21 in a direction perpendicular to the light incident surface 15. Further, a pitch P of the lenticular lens structures is the sum of the second width W3 of the lenticular lens structures and a distance between the lenticular lens structures. The pitch P of the lenticular lens structures may be set continuously or not continuously, wherein the pitch P may be variable.

In this embodiment, the lenticular lens structures 21 are prismatic or cylindrical, and more specifically, the lenticular lens structures 21 may be in the shape of a triangular prism; and the lenticular lens structures 21 may cave in the light exit surface 13. In another embodiment, as shown in FIG. 17b (the microstructures on the bottom surface are not shown), the lenticular lens structures 21 may be cylindrical and protrude from the light exit surface 13.

By means of the lenticular lens structures 21 on the light exit surface, the viewing angle in the horizontal direction can be reduced.

By controlling the structural shape of the lenticular lens structures, the luminous intensity distribution of the light guide plate in the horizontal direction can be adjusted; and by arranging the lenticular lens structures 21 on the light exit surface, the viewing angle is further reduced to realize smaller-viewing angle display and improve the axial brightness.

In this embodiment, referring to FIG. 18, a period n of the microprism structures 392 is 10 μm-40 μm, and each microprism structure comprises a fourth surface 394 and a fifth surface 395 which are connected to each other. An included angle Φ between the fourth surface 394 and the fifth surface 395 of each microprism structure is 50°-90°, and more preferably, the included angle Φ between the fourth surface 394 and the fifth surface 395 of each microprism structure is 60°-76°. Wherein, the period n is a distance between two adjacent microprism structures 392 (a distance between corresponding positions of two adjacent microprism structures 392, for example, a distance between the vertexes of two adjacent microprism structures 392).

In this embodiment, a sharp corner is formed at a joint between the fourth surface 394 and the fifth surface 395.

In the light guide plate, referring to FIGS. 19a and 19b, when the tilt angle α of the microstructure on the light guide plate satisfies the distribution in FIG. 15a, β=80°, W1 satisfies the distribution in FIG. 16a, L1=100 μm, the light guide plate is made from polycarbonate (PC), the thickness of the light guide plate is T=0.5 mm, the lenticular lens structures 21 are arranged on the light exit surface 13 and the pitch p is 50 μm, an intensity peak angle of light exiting from the light guide plate within the horizontal viewing angle is 0°, the FWHM in the horizontal direction is 27°, an intensity peak angle of the light exiting from the light guide plate within the vertical viewing angle is 76°, and the FWHM in the vertical direction is 18°, indicating that the viewing angle is small, and the light guide plate can be can be used as a privacy light guide plate.

In the backlight unit, when the tilt angle α of the microstructure on the light guide plate satisfies the distribution in FIG. 15a, β=80°, W1 satisfies the distribution in FIG. 16a, L1=100 μm, the light guide plate is made from PC, the thickness of the light guide plate is T=0.5 mm, the lenticular lens structures 21 are arranged on the light exit surface, the pitch p is 50 μm, the vertex angle Φ of the microprism structures 392 of the turning film 39 is 68°, the period n is 18 μm and the height H4 of the microprism structures 392 is 14 μm, the distribution of the relative intensity of the backlight unit in this embedment is shown in FIGS. 20a and 20b, and the distribution of the luminous intensity of the backlight unit in this embodiment is shown in FIGS. 20c and 20d. It can be seen that the intensity peak angle of light exiting from the backlight unit within the horizontal viewing angle in this embodiment is 0°, the FWHM in the horizontal direction is 27°, the intensity peak angle of light exiting from the backlight unit within the vertical viewing angle is 0°, the FWHM in the vertical direction is 18°, and the on-axis luminous intensity is 7400 cd/m². The simulated distribution of the luminous intensity of the backlight unit in this embodiment is shown in FIG. 20e. It can be seen that the viewing angle of the backlight unit is small and the light guide plate can be used as a privacy backlight unit.

The matching relation between the light guide plate made from PC and the vertex of the microprism on the turning film of the backlight unit in this embodiment is shown in Table 2.

Table 2 Table of the matching relation between different angles of the microstructures and the vertex of the microprism on the turning film (PC light guide plate)

TABLE 1

| | | Vertex |
|---|---|---|
| | Intensity | angle |
| | peak | of the |
| Angle | angle | micro- |
| of the | in the | prism |
| micro- | vertical | on the |
| structures | direction | turning |
| α (°) | (°) | film (°) |
| 0.5 | 78.3 | 71 |
| 1 | 76.5 | 70 |
| 2 | 72.9 | 68 |
| 3 | 68.6 | 64 |
| 4 | 65.7 | 63 |
| 5 | 63.9 | 62 |

The matching relation between the light guide plate made from PMMA and the turning film of the backlight unit in this embodiment is show in Table 3.

Table 3 Table of the matching relation between different angles of the microstructures and the vertex of the microprism on the turning film (PMMA light guide plate)

TABLE 2

| | | Vertex |
|---|---|---|
| | Intensity | angle |
| | peak | of the |
| Angle | angle | micro- |
| of the | in the | prism |
| micro- | vertical | on the |
| structures | direction | turning |
| α (°) | (°) | film (°) |
| 0.5 | 76.5 | 70 |
| 1 | 75.5 | 69 |
| 2 | 72.9 | 68 |
| 3 | 71 | 67 |
| 4 | 70.2 | 66 |
| 5 | 68.6 | 64 |

It can be understood that, referring to FIG. 21, a filleted corner is formed at the joint between the fourth surface 394 and the fifth surface 395, and the radius of curvature of the filleted corner is 2 μm-10 μm. By designing the joint between the fourth surface 394 and the fifth surface 395 into a filleted corner, the wastage or damage to a sharp corner in the assembly process of the turning film can be reduced.

It can be understood that the section lines, in the reference plane R1, of the first surface 171 and the second surface 191 may form a first arc, and the included angle α between a tangent of the first arc and the bottom surface 11 is 0.5°-5°. It can be understood that the section lines, in the reference plane R1, of the first surface 171 and the second surface 191 may be formed by a straight line and an arc (that is, the section lines comprise a straight line and an arc), and the included angle α between the straight line and the bottom surface 11 and the included angle α between a tangent of the arc and the bottom surface are 0.5°-5°.

It can be understood that the section line, in the reference plane R1 perpendicular to the light incident surface 15 and the light exit surface 13, of the third surface 174 may be a second arc, and an included angle between a tangent of the second arc and the bottom surface 11 is 40°-80°. It can be understood that the section line, in the reference plane R1 perpendicular to the light incident surface 15 and the light exit surface 13, of the third surface 174 may be a broken line, and an included angle between the broken line and the bottom surface 11 is 40°-80°. At least part of the third surface 174 is a conical surface, and at least part of the section line, in the reference plane parallel to the bottom surface 11, of the third surface 174 is an arc.

It can be understood that the section lines, in the reference plane R1 perpendicular to the light incident surface and the light exit surface, of the first surface 171 and the third surface 174 are in arc transition, and arc transition is formed at the vertex of the protruding part 19.

In another embodiment, the microstructure comprises a concave part 17 and a protruding part 19, wherein the protruding part 19 protrudes towards a side facing away from the light exit surface 13, and the concave part 17 caves in towards the light exit surface 13. The concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171 (that is, the first surface 171 and the second surface 191 are located in a same plane). The microstructure further comprises a third surface 174, the second surface 191 is connected to the third surface 174, and one part of the third surface 174 and the second surface 191 are two sides of the protruding part 19 respectively. Specifically, a depth (H1) of the concave part of the microstructure is 0.2 μm-1 μm, a height (H2) of the protruding part is 0.5 μm-8 μm, the ratio of the depth (H1) of the concave part to the height (H2) of the protruding part of the microstructure is 1/12-¼, a length L1 of the microstructure is 50 μm-150 μm, and a first width W1 of the microstructure is 10 μm-120 μm.

According to the backlight unit in this embodiment, the microstructures comprising the concave parts and the protruding parts are arranged on the bottom surface of the light guide plate, and the first surfaces and the second surfaces are used together to enlarge the area of an effective reflecting surface, thus improving the light coupling efficiency; moreover, the protruding parts can prevent adsorption between the light guide plate and other films and top whitening phenomenon; in addition, the included angle between the section line of the first surface in the reference plane R1 and the bottom surface of the light guide plate set to 0.5°-5°, such that the FWHM of the luminous intensity within the full viewing angle in the vertical direction of the light guide plate is small, and the intensity peak angle is 76°, such that four layers of films (an up diffuser, a down diffuser, a down brightness enhancement film and an up brightness enhancement film) in an existing backlight unit can be replaced with one turning film. On one hand, the structure of the backlight unit is simplified, raw materials are saved, and the assembly cost is reduced; on the other hand, the light use efficiency of the backlight unit can be improved, and compared with existing backlight units, the light use efficiency is improved by about 20%-30%, and the gain of on-axis brightness is 50%.

### Embodiment 5

The invention further provides a backlight unit, which may be applied to a transmissive liquid crystal display panel. Referring to FIG. 22, the backlight unit in Embodiment 5 comprises a light source 31, a light guide plate 33, a reflector 35, a first diffuser 41 and a turning film, wherein the light guide plate 33 comprises a bottom surface 11, a light exit surface 13 and a light incident surface 15, the bottom surface 11 and the light exit surface 33 are arranged opposite to each other, and the light incident surface 15 connects the bottom surface 11 and the light exit surface 13. The light source 31 is arranged on one side of the light incident surface 15 of the light guide plate 33, the reflector 35 and the turning film 39 are arranged on two sides of the light guide plate 33 respectively, the turning film 39 is arranged close to the light exit surface 13 of the light guide plate, a plurality of microprism structures 392 are arranged on the turning films 39 and protrude towards the light exit surface 13, and the first diffuser 41 is arranged on a side, facing away from the light guide plate 33, of the turning film 39. Referring to FIG. 23, a plurality of microstructures are arranged on the bottom surface 11. The microstructure comprises a protruding part 19 and a concave part 17, wherein the protruding part 19 protrudes towards a side facing away from the light exit surface 13, the concave part 17 caves in towards the light exit surface 13, the concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171. Section lines, in a reference plane R1 perpendicular to the light incident surface 15 and the light exit surface 13, of the first surface 171 and the second surface 191 form a first straight line, and an included angle α between the first straight line and the bottom surface 11 is 5°-35°.

In this embodiment, a depth H1 of the concave part 17 of the microstructure is 2 μm-15 μm, a height H2 of the protruding part 19 is 0.3 μm-3 μm, the ratio of the depth H1 of the concave part 17 to the height H2 of the protruding part 19 of the microstructure is 4-12, a length L1 of the microstructure is 10 μm-100 μm, and a first width W1 of the microstructure is 15 μm-150 μm.

In this embodiment, the microstructure further comprises a third surface 174, wherein the first surface 171 is connected to the third surface 174, and one part of the third surface 174 and the first surface 171 are two sides of the concave part respectively.

A section line, in the reference plane R1 perpendicular to the light incident surface 15 and the light exit surface 13, of the third surface 174 is a second straight line, a second arc or a broken line, and an included angle between the second straight line and the bottom surface 11, between a tangent of the second arc and the bottom surface 11, or between the broken line and the bottom surface 11 is 40°-80°.

Specifically, the section line, in the reference plane R1 perpendicular to the light incident surface 15 and the light exit surface 13, of the third surface 174 is a second straight line, and an included angle between the second straight line and the bottom surface 11 is 40°-80°.

Specifically, a section line, in a reference plane parallel to the bottom surface 11, of the third surface 174 is a straight line.

Specifically, the section lines, in the reference plane R1 perpendicular to the light incident surface and the light exit surface, of the first surface 171 and the third surface 174 form a sharp corner at a joint between the first surface 171 and the third surface 174, and a sharp corner is formed at the vertex of the protruding part 19.

In some embodiments, the section lines, in the reference plane R1 perpendicular to the light incident surface 15 and the light exit surface 13, of the first surface 171 and the third surface 174 are in arc transition; and/or, arc transition is formed at the vertex of the protruding part 19.

In this embodiment, the concave part 17 of the microstructure is prismatic, two adjacent sides of a microprism form the first surface 171 and the third surface 174 of the concave part 17 respectively, and the section lines, in the reference plane R1 perpendicular to the light incident surface and the light exit surface, of the first surface 171 and the third surface 174 form a sharp corner at a joint between the first surface 171 and the third surface 174. Specifically, in this embodiment, the concave part 17 is a triangular prism. It can be understood that the concave part 17 may be in other shapes shown in FIGS. 4a-4g.

In this embodiment, a plurality of lenticular lens structures (lenti structures) 21 are arranged on the light exit surface 13 of the light guide plate.

Specifically, the lenticular lens structures 21 extend in a direction parallel to the light incident surface 15, a depth H3 of the lenticular lens structures 21 is 3 μm-20 μm, and a second width W3 of the lenticular lens structures 21 is 10 μm-60 μm. Wherein, the depth H3 is a size of the lenticular lens structures 21 in a direction perpendicular to the light exit surface 13, and the second width W3 is a size of the lenticular lens structures 21 in a direction perpendicular to the light incident surface 15.

Specifically, the lenticular lens structures 21 are prismatic or cylindrical, and more specifically, the lenticular lens structures 21 may be in the shape of a triangular prism; and the lenticular lens structures 21 may cave in the light exit surface 13. In another embodiment, the lenticular lens structures 21 may be cylindrical and protrude from the light exit surface 13.

In this embodiment, a plurality of V-shaped open structures (V-cuts) may be arranged on the light incident surface 15 of the light guide plate.

In this embodiment, referring to FIG. 24, a period n of the microprism structures 392 is 10 μm-40 μm, and each microprism structure comprises a fourth surface 394 and a fifth surface 395 which are connected to each other. An included angle Φ between the fourth surface 394 and the fifth surface 395 of each microprism structure is 50°-90°, and more preferably, the included angle Φ between the fourth surface 394 and the fifth surface 395 of each microprism structure is 60°-76°. Wherein, the period n is a distance between two adjacent microprism structures 392 (a distance between corresponding positions of two adjacent microprism structures 392, for example, a distance between vertexes of two adjacent microprism structures 392).

In this embodiment, a sharp corner is formed at a joint between the fourth surface 394 and the fifth surface 395.

In this embodiment, the included angle between the first straight line and the bottom surface 11 or the included angle between a tangent of a first arc and the bottom surface 11 is 5°-27.5°, and the included angle Φ between the fourth surface 394 and the fifth surface 395 of each microprism structure 392 is 61°-70°. More specifically, the included angle between the first straight line and the bottom surface 11 or the included angle between the tangent of the first arc and the bottom surface 11 is 5°-25°, and the included angle Φ between the fourth surface 394 and the fifth surface 395 of each microprism structure 392 is 63°.

FIG. 25 illustrates the distribution of the luminous intensity of the backlight unit in this embodiment in case of different tilt angles α of the microstructure on the light guide plate when the vertex angle Φ of the microprism on the turning film 29 is 63°.

The matching relation between the light guide plate and the vertex angle of the microprism on the turning film of the backlight unit in this embodiment is shown in Table 4. It can be known from Table 4 that the change of the tilt angle of the microstructure has little influence on the angle Φ of the turning film, and when the tilt angle of the microstructure changes within 5°-27.5°, the angle Φ of the microprism on the turning film ranges from 61° to 64°. Therefore, in the aspect of mass production cost and mass production complexity, a turning film of the same structure can be adopted to greatly improve the mass production of the backlight unit, reduce the tolerance, and increase the yield.

It should be noted here that the matching relation shown in FIG. 4 is determined based on a base material, with a specific refractive index, of the light guide plate (such as, PC with a refractive index of 1.59). The applicant of the application finds, by theorical analysis and experiments, that when the light guide plate is made from base materials with other refractive indexes (such as PMMA), the vertex angle of the microprism on the turning film may range from 63° to 70°.

Table 4 Table of the matching relation between different angles of the microstructures and the vertex angle of the turning film

TABLE 3

| | | Vertex |
|---|---|---|
| | Intensity | angle |
| | peak | of the |
| Angle | angle | micro- |
| of the | in the | prism |
| micro- | vertical | on the |
| structures | direction | turning |
| α (°) | (°) | film (°) |
| 5 | 67.5 | 63 |
| 7.5 | 65.7 | 63 |
| 10 | 62.5 | 63.5 |
| 12.5 | 60.3 | 64 |
| 15 | 60.3 | 63.5 |
| 17.5 | 58.5 | 62.5 |
| 20 | 53.1 | 62 |
| 22.5 | 53.1 | 61.5 |
| 25 | 51.3 | 61 |
| 27.5 | 46.5 | 61 |

According to the backlight unit in this embodiment, the luminous intensity of the backlight unit within the horizontal viewing angle and within the vertical viewing angle is high and concentrated in a small area of about 0°. The comparation in the luminous intensity distributions of the light guide plate in this embodiment, a common backlight combination (not provided with a turning film) and a common backlight unit (a common light guide plate, not provided with a turning film) are shown in FIGS. 26a and 26b. In this embodiment, when the tilt angle α of the microstructure on the light guide plate satisfies α=15°, β=80°, W1=20 μm, L1=100 μm, the light guide plate is made from PC, the thickness of the light guide plate is T=0.5 mm, the pitch p of the lenticular lens structures 21 is 50 μm, the vertex angle Φ of the microprism structures 392 of the turning film 39 is 64°, the period n is 18 μm and the height H4 of the microprism structures 392 is 14 μm, the distribution of the luminous intensity of the backlight unit in this embedment is shown in FIG. 27. Compared with conventional backlight units, the gain of on-axis brightness of the backlight unit in this embodiment is 42%.

In this embodiment, referring to FIG. 22, when the tilt angle α of the microstructure on the light guide plate of the backlight unit satisfies α=15°, β=65°, W1=20 μm, L1-20 μm, the light guide plate is made from PMMA, the thickness of the light guide plate is T=0.5 mm, the pitch p of the lenticular lens structures 21 is 50 μm, the vertex angle @ of the microprism structures 392 of the turning film 39 is 64°, the period n is 18 μm and the height H4 of the microprism structures 392 is 14 μm, the transmissivity of the first diffuser 41 is 90% and the haze is 50%, the distribution of the luminous intensity of the backlight unit in this embedment is shown in FIG. 28. Compared with conventional backlight units, the gain of on-axis brightness of the backlight unit in this embodiment is 23%, the intensity peak angle of the luminous intensity is 0°, the FWHM in the horizontal direction is 60.8°, and the FWHM in the vertical direction is 42.8°.

In this embodiment, referring to FIG. 29a, the backlight unit further comprises a second diffuser 43, wherein the second diffuser 43 is arranged between the turning film 39 and the light guide plate 33. According to the backlight unit in this embodiment, when the tilt angle α of the microstructure on the light guide plate of the backlight unit satisfies α=15°, β=65°, W1=20 μm, L1-20 μm, the light guide plate is made from PC, the thickness of the light guide plate is T=0.5 mm, the pitch p of the lenticular lens structures 21 is 50 μm, the vertex angle Φ of the microprism structures 392 of the turning film 39 is 64°, the period n is 18 μm and the height H4 of the microprism structures 392 is 14 μm, the transmissivity of the first diffuser 41 and the second diffuser 43 is 90% and the haze is 50%, the distribution of the luminous intensity of the backlight unit in this embedment is shown in FIG. 29b. Compared with conventional backlight units, the gain of on-axis brightness of the backlight unit in this embodiment is 13%, the intensity peak angle of the luminous intensity is 0°, the FWHM in the horizontal direction is 65.1°, and the FWHM in the vertical direction is 50.7°.

In some embodiments, the first diffuser 41 and/or the second diffuser 43 are haze-controllable diffusers, and the first diffuser 41 and/or the second diffuser 43 are integrated on the turning film 39.

According to the backlight unit in this embodiment, the microstructures comprising the concave parts and the protruding parts are arranged on the bottom surface of the light guide plate, and the first surfaces and the second surfaces are used together to enlarge the area of an effective reflecting surface, thus improving the light coupling efficiency; moreover, the protruding parts can prevent adsorption between the light guide plate and other films and top whitening phenomenon; in addition, a brightness enhancement film of the backlight unit can be omitted, thus reducing film layers of the backlight unit, simplifying the structure and assembly process and improving the light use efficiency. The backlight unit in this embodiment has a moderate viewing angle in the vertical direction, and thus can be applied to scenarios requiring a medium viewing angle.

It can be understood that a filleted corner is formed at a joint between the fourth surface 394 and the fifth surface 395, and the radius of curvature of the filleted corner is 2 μm-10 μm. By designing the joint between the fourth surface 394 and the fifth surface 395 into a filleted corner, the wastage or damage to a sharp corner in the assembly process of the turning film can be reduced. In a case where the joint between the fourth surface 394 and the fifth surface 395 is designed into a filleted corner, the distribution of the luminous intensity of the backlight unit in FIG. 22 is shown in FIG. 30.

It can be understood that the section lines, in the reference plane R1, of the first surface 171 and the second surface 191 may form a first arc, and the included angle α between a tangent of the first arc and the bottom surface 11 is 5°-35°. It can be understood that the section lines, in the reference plane R1, of the first surface 171 and the second surface 191 may be formed by a straight line and an arc (that is, the section lines comprise a straight line and an arc), and the included angle α between the straight line and the bottom surface 11 and the included angle α between a tangent of the arc and the bottom surface are 5°-35°.

In this embodiment, the included angle between the first straight line and the bottom surface 11 or the included angle between the tangent of the first arc and the bottom surface 11 is 5°-27.5°, and the included angle between the fourth surface 394 and the fifth surface 395 of each microprism structure 392 is 61°-70°.

It can be understood that the section line, in the reference plane R1 perpendicular to the light incident surface 15 and the light exit surface 13, of the third surface 174 may be a second arc, and an included angle between a tangent of the second arc and the bottom surface 11 is 40°-80°. It can be understood that the section line, in the reference plane R1 perpendicular to the light incident surface 15 and the light exit surface 13, of the third surface 174 may be a broken line, and an included angle between the broken line and the bottom surface 11 is 40°-80°. At least part of the third surface 174 is a conical surface, and at least part of the section line, in the reference plane parallel to the bottom surface 11, of the third surface 174 is an arc.

It can be understood that the section lines, in the reference plane R1 perpendicular to the light incident surface and the light exit surface, of the first surface 171 and the third surface 174 are in arc transition, and arc transition is formed at the vertex of the protruding part 19.

In another embodiment, the microstructure comprises a concave part 17 and a protruding part 19, wherein the protruding part 19 protrudes towards a side facing away from the light exit surface 13, and the concave part 17 caves in towards the light exit surface 13. The concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171 (that is, the first surface 171 and the second surface 191 are located in a same plane). The microstructure further comprises a third surface 174, the second surface 191 is connected to the third surface 174, and one part of the third surface 174 and the second surface 191 are two sides of the protruding part 19 respectively. Specifically, a depth H1 of the concave part of the microstructure is 0.3 μm-3 μm, a height H2 of the protruding part is 2 μm-15 μm, the ratio of the depth H1 of the concave part 17 to the height H2 of the protruding part 19 of the microstructure is 1/12-¼, a length L1 of the microstructure is 10 μm-100 μm, and a first width W1 of the microstructure is 15 μm-150 μm.

According to the backlight unit in this embodiment, the microstructures comprising the concave parts and the protruding parts are arranged on the bottom surface of the light guide plate, and the first surfaces and the second surfaces are used together to enlarge the area of an effective reflecting surface, thus improving the light coupling efficiency; moreover, the protruding parts can prevent adsorption between the light guide plate and other films and top whitening phenomenon; in addition, the included angle between the section line of the first surface in the reference plane R1 and the bottom surface of the light guide plate set to 5°-35°, such that the FWHM in the vertical direction of the light guide plate is 25°-65°, such that three layers of films (a down diffuser, a down brightness enhancement film and an up brightness enhancement film) in an existing backlight unit can be replaced with one turning film. On one hand, the structure of the backlight unit is simplified, raw materials are saved, and the assembly cost is reduced; on the other hand, the light use efficiency of the backlight unit can be improved, and compared with existing backlight units, the light use efficiency is improved by about 20%-30%.

### Embodiment 6

The invention further provides a backlight unit, which may be applied to a transmissive liquid crystal display panel. Referring to FIG. 31, the backlight unit in Embodiment 6 comprises a light source 31, a light guide plate 33, a reflector 35 and a first diffuser 41, wherein the light guide plate 33 comprises a bottom surface 11, a light exit surface 13 and a light incident surface 15, the bottom surface 11 and the light exit surface 33 are arranged opposite to each other, and the light incident surface 15 connects the bottom surface 11 and the light exit surface 13. The light source 31 is arranged on one side of the light incident surface 15 of the light guide plate 33, and the reflector 35 and the first diffuser 41 are arranged on two sides of the light guide plate 33 respectively. Referring to FIG. 32, a plurality of microstructures are arranged on the bottom surface 11. The microstructure comprises a protruding part 19 and a concave part 17, wherein the protruding part 19 protrudes towards a side facing away from the light exit surface 13, the concave part 17 caves in towards the light exit surface 13, the concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171. Section lines, in a reference plane R1 perpendicular to the light incident surface 15 and the light exit surface 13, of the first surface 171 and the second surface 191 form a first straight line, and an included angle α between the first straight line and the bottom surface 11 is 35°-55°.

In this embodiment, a depth H1 of the concave part 17 of the microstructure is 4 μm-20 μm, a height H2 of the protruding part 19 is 0.2 μm-3 μm, the ratio of the depth H1 of the concave part 17 to the height H2 of the protruding part 19 of the microstructure is 4-12, a length L1 of the microstructure is 10 μm-80 μm, and a first width W1 of the microstructure is 15 μm-150 μm.

In this embodiment, the microstructure further comprises a third surface 174, wherein the first surface 171 is connected to the third surface 174, and one part of the third surface 174 and the first surface 171 are two sides of the concave part 17 respectively.

A section line. In the reference plane R1 perpendicular to the light incident surface 15 and the light exit surface 13, of the third surface 174 is a second straight line, a second arc or a broken line, and an included angle between the second straight line and the bottom surface 11, between a tangent of the second arc and the bottom surface 11, or between the broken line and the bottom surface 11 is 40°-80°.

Specifically, the section line, in the reference plane R1 perpendicular to the light incident surface 15 and the light exit surface 13, of the third surface 174 is a second straight line, and an included angle between the second straight line and the bottom surface 11 is 40°-80°.

Specifically, a section line, in a reference plane parallel to the bottom surface 11, of the third surface 174 is a straight line.

Specifically, at least part of the third surface 174 is a conical surface, and at least part of the section line, in the reference plane parallel to the bottom surface 11, of the third surface 174 is an arc.

In some embodiments, the section lines, in the reference plane R1 perpendicular to the light incident surface 15 and the light exit surface 13, of the first surface 171 and the third surface 174 are in arc transition; and/or, arc transition is formed at the vertex of the protruding part 19.

Specifically, the section lines, in the reference plane R1 perpendicular to the light incident surface and the light exit surface, of the first surface 171 and the third surface 174 form a sharp corner at a joint between the first surface 171 and the third surface 174, and a sharp corner is formed at the vertex of the protruding part 19.

In this embodiment, the concave part 17 of the microstructure is prismatic, two adjacent sides of a microprism form the first surface 171 and the third surface 174 of the concave part 17 respectively, and the section lines, in the reference plane R1 perpendicular to the light incident surface and the light exit surface, of the first surface 171 and the third surface 174 form a sharp corner at a joint between the first surface 171 and the third surface 174. Specifically, in this embodiment, the concave part 17 is a triangular prism. It can be understood that the concave part 17 may be in other shapes shown in FIGS. 4a-4g.

In this embodiment, a plurality of lenticular lens structures (lenti structures) 21 are arranged on the light exit surface 13 of the light guide plate.

Specifically, the lenticular lens structures 21 extend in a direction parallel to the light incident surface 15, a depth H3 of the lenticular lens structures 21 is 3 μm-20 μm, and a second width W3 of the lenticular lens structures 21 is 10 μm-60 μm. Wherein, the depth H3 is a size of the lenticular lens structures 21 in a direction perpendicular to the light exit surface 13, and the second width W3 is a size of the lenticular lens structures 21 in a direction perpendicular to the light incident surface 15.

Specifically, the lenticular lens structures 21 are prismatic or cylindrical, and more specifically, the lenticular lens structures 21 may be in the shape of a triangular prism; and the lenticular lens structures 21 may cave in the light exit surface 13. In another embodiment, the lenticular lens structures 21 may be cylindrical and protrude from the light exit surface 13.

In this embodiment, a plurality of V-shaped open structures (V-cuts) may be arranged on the light incident surface 15 of the light guide plate.

In this embodiment, the first diffuser 41 is a haze-controllable diffuser.

As for the light guide plate in the backlight unit in this embodiment, when the tilt angle α of the microstructure on the light guide plate satisfies α=45°, β=80°, W1=20 μm, L1-20 μm, the light guide plate is made from PC, the thickness of the light guide plate is T=0.5 mm, the distribution of the luminous intensity of the light guide plate is shown in FIG. 33a. The intensity peak angle in the vertical viewing angle of the backlight unit is 3°, the FWHM in the horizontal direction is 65°, the FWHM in the vertical direction is 70°, and the luminous intensity of the light guide plate is concentrated in the vicinity of the axial viewing angle 0° by controlling the tilt angle of the first surfaces and the second surfaces of the microstructures. Compared with conventional light guide plates, the intensity peak angle of the luminous intensity of the light guide plate is closer to the normal direction of the light exit surface of the light guide plate, such that the luminous intensity can be adjusted towards the axial viewing angle more easily; and the light guide plate has a large FWHM of the luminous intensity and thus can adapt to large-angle display such as a TV.

According to the backlight unit in this embodiment, when the tilt angle α of the microstructure on the light guide plate satisfies α=45°, β=80°, W1-20 μm, L1=20 μm, the light guide plate is made from PMMA, the thickness of the light guide plate is T=0.5 mm, the pitch p of the lenticular lens structures 21 is 50 μm, the vertex angle Φ of the microprism structures 392 of the turning film 39 is 64° and the period n is 18 μm, the distribution of the luminous intensity of the backlight unit in this embedment is shown in FIG. 33b. Compared with conventional backlight units, the gain of on-axis brightness of the backlight unit in this embodiment is 13%, the intensity peak angle of the luminous intensity is 0°, the FWHM in the horizontal direction is 78°, and the FWHM in the vertical direction is 53°. It thus can be seen that the backlight unit in this embodiment can obtain an emergent viewing angle 0° and viewing angle indicators of conventional light guide plates 33 merely by means of the high-transmissivity and high-haze first diffuser 41. Compared with conventional backlight units, the light loss caused by the arrangement of other films (a down diffuser, a down brightness enhancement film and an up enhancement film) is reduced, the light use efficiency of the light guide plate 33 can be improved by 20%, and the backlight unit has a broad viewing angle and can be used for large-angle display. In addition, in the aspect of the yield in the assembly process of the backlight unit and the structural cost of the unit, the yield of the backlight unit is greatly increased, and the cost is reduced.

According to the backlight unit in this embodiment, the luminous intensity distribution of the whole unit can be adjusted by controlling the haze or Gaussian spread angle of the first diffuser. Specifically, when the Gaussian spread angle of the first diffuser changes from 5° to 50°, the FWHM of the luminous intensity of the backlight unit can change from 45° to 85°. As shown in FIG. 33c which illustrates the distribution of the luminous intensity of the backlight unit when the Gaussian spread angle is set to 40°, the FWHM in the horizontal direction is 81°, and the FWHM in the vertical direction is 71°.

According to the backlight unit in this embodiment, the microstructures comprising the concave parts and the protruding parts are arranged on the bottom surface of the light guide plate, and the first surfaces and the second surfaces are used together to enlarge the area of an effective reflecting surface, thus improving the light coupling efficiency; moreover, the protruding parts can prevent adsorption between the light guide plate and other films and top whitening phenomenon; in addition, a brightness enhancement film of the backlight unit can be omitted, thus reducing film layers of the backlight unit, simplifying the structure and assembly process and improving the light use efficiency. Furthermore, the backlight unit in this embodiment has a broad viewing angle and thus can be used for large-angle display.

It can be understood that the section lines, in the reference plane R1, of the first surface 171 and the second surface 191 may form a first arc, and the included angle α between a tangent of the first arc and the bottom surface 11 is 35°-35°. It can be understood that the section lines, in the reference plane R1, of the first surface 171 and the second surface 191 may be formed by a straight line and an arc (that is, the section lines comprise a straight line and an arc), and the included angle α between the straight line and the bottom surface 11 and the included angle α between a tangent of the arc and the bottom surface are 35°-35°.

It can be understood that the section line, in the reference plane R1 perpendicular to the light incident surface 15 and the light exit surface 13, of the third surface 174 may be a second arc, and an included angle between a tangent of the second arc and the bottom surface 11 is 40°-80°. It can be understood that the section line, in the reference plane R1 perpendicular to the light incident surface 15 and the light exit surface 13, of the third surface 174 may be a broken line, and an included angle between the broken line and the bottom surface 11 is 40°-80°. At least part of the third surface 174 is a conical surface, and at least part of the section line, in the reference plane parallel to the bottom surface 11, of the third surface 174 is an arc.

It can be understood that the section lines, in the reference plane R1 perpendicular to the light incident surface and the light exit surface, of the first surface 171 and the third surface 174 are in arc transition, and arc transition is formed at the vertex of the protruding part 19.

In another embodiment, the microstructure comprises a concave part 17 and a protruding part 19, wherein the protruding part 19 protrudes towards a side facing away from the light exit surface 13, and the concave part 17 caves in towards the light exit surface 13. The concave part 17 comprises a first surface 171 facing the interior of the light guide plate, the first surface 171 faces the light incident surface 15, the protruding part 19 comprises a second surface 191 facing the interior of the light guide plate, and the second surface 191 is an extended surface of the first surface 171 (that is, the first surface 171 and the second surface 191 are located in a same plane). The microstructure further comprises a third surface 174, the second surface 191 is connected to the third surface 174, and one part of the third surface 174 and the second surface 191 are two sides of the protruding part 19 respectively. Specifically, a depth H1 of the concave part 17 of the microstructure is 0.2 μm-3 μm, a height H2 of the protruding part 19 is 4 μm-20 μm, the ratio of the depth H1 of the concave part 17 to the height H2 of the protruding part 19 of the microstructure is 1/12-¼, a length L1 of the microstructure is 10 μm-80 μm, and a first width W1 of the microstructure is 15 μm-150 μm.

In this way, the viewing angle in the horizontal direction and the viewing angle in the vertical direction can be further expanded by means of two diffusers, and some defects in the backlight unit can be covered up, such that the technique requirements for the backlight unit in different application scenarios are satisfied.

According to the backlight unit in this embodiment, the microstructures comprising the concave parts and the protruding parts are arranged on the bottom surface of the light guide plate, and the first surfaces and the second surfaces are used together to enlarge the area of an effective reflecting surface, thus improving the light coupling efficiency; moreover, the protruding parts can prevent adsorption between the light guide plate and other films and top whitening phenomenon; in addition, the included angle between the section line of the first surface in the reference plane R1 and the bottom surface of the light guide plate set to 35°-55°, the luminous intensity of the light guide plate is concentrated in the vicinity of the axial viewing angle 0°, such that three layers of films (a down diffuser, a down brightness enhancement film and an up brightness enhancement film) in an existing backlight unit can be directly omitted. On one hand, the structure of the backlight unit is simplified, raw materials are saved, and the assembly cost is reduced; on the other hand, the light use efficiency of the backlight unit is improved, and compared with conventional backlight units, the gain of on-axis brightness is about 20%-30%.

It can be understood that the structures or features in the above embodiments can be combined freely without conflicts.

In the description, unless otherwise expressly stated and defined, terms “mount”, “link” and “connect” should be broadly understood. For example, “connect” may refer to fixed connection, detachable connection or integrated connection; or, mechanical connection or electrical connection; or, direct connection, indirect connection by an intermediate medium, or internal connection of two elements. Those ordinarily skilled in the art can appreciate the specific meanings of these terms base the case may be.

In the description, terms “upper”, “lower”, “front”, “back”, “left”, “right”, “top”, “bottom”, “inner”, “outer”, “vertical” and “horizontal” are used to indicate directional or positional relations based on the accompanying drawings merely for a clear and convenient description of the technical solutions of the invention, and thus should not be construed as limitations of the invention.

In the description, terms “comprise” and “include” or any other variants are intended to indicate non-exclusive inclusion, so in addition to elements that are clearly listed, other elements that are not clearly listed may also be included.

The above embodiments are merely specific ones of the invention, and the protection scope of the invention is not limited to the above description. All transformations or substitutions that can be easily obtained by any skilled in the art within the technical scope disclosed by the invention should also fall within the protection scope of the invention. Therefore, the protection scope of the invention should be defined by the appended claims.

1. A light guide plate, comprising a bottom surface, a light exit surface and a light incident surface, wherein the bottom surface and the light exit surface are arranged opposite to each other, the light incident surface connects the bottom surface and the light exit surface, a plurality of microstructures are formed on the bottom surface; and the microstructure comprises a protruding part and a concave part, the protruding part protrudes towards a side facing away from the light exit surface, the concave part caves in towards the light exit surface, the concave part comprises a first surface facing an interior of the light guide plate, the first surface faces the light incident surface, the concave part comprises a second surface facing the interior of the light guide plate, and the second surface is an extended surface of the first surface.

2. The light guide plate according to claim 1, wherein section lines, in a reference plane perpendicular to the light incident surface and the light exit surface, of the first surface and the second surface form a first straight line and/or a first arc, and an included angle between the first straight line and the bottom surface or between a tangent of the first arc and the bottom surface is 0.5°-55°.

3. The light guide plate according to claim 1, wherein section lines, in a reference plane perpendicular to the light incident surface and the light exit surface, of the first surface and the second surface form a first straight line and/or a first arc, wherein, an included angle between the first straight line and the bottom surface or between a tangent of the first arc and the bottom surface is 0.5°-55°; or, an included angle between the first straight line and the bottom surface or between a tangent of the first arc and the bottom surface is 5°-35°;
or, an included angle between the first straight line and the bottom surface or between a tangent of the first arc and the bottom surface is 35°-55°; or, an included angle between the first straight line and the bottom surface or between a tangent of the first arc and the bottom surface is 30°-50°.

4. The light guide plate according to claim 1, wherein the concave part is in the shape of a truncated cone formed by partially cutting away a top and a side of a cone, a top surface of the truncated cone inclines with respect to an axis of the truncated cone and intersects with a bottom surface of the truncated cone at a point, the bottom surface of the truncated cone is perpendicular to the axis of the truncated cone, and the top surface forms the first surface; or, the concave part is in the shape of a truncated cone formed by partially cutting away a top and a side of a cone, a top surface of the truncated cone inclines with respect to an axis of the truncated cone and intersects with a bottom surface of the truncated cone along a straight line, the bottom surface of the truncated cone is perpendicular to the axis of the truncated cone, and the top surface forms the first surface; or, the concave part is in the shape of a semicylinder formed by partially cutting away a top and a side of a cylinder, a top surface of the semicylinder inclines with respect to an axis of the semicylinder and intersects with a bottom surface of the semicylinder at a point, and the top surface forms the first surface; or, the concave part is in the shape of a cylinder, a top surface of the cylinder inclines with respect to an axis of the cylinder and intersects with a bottom surface of the cylinder at a point, and the top surface forms the first surface; or, the concave part in the shape of a semicylinder formed by partially cutting away a top and a side of a cylinder, a top surface of the semicylinder inclines with respect to an axis of the semicylinder and intersects with a bottom surface of the semicylinder along a straight line, and the top surface forms the first surface; or, the concave part is in the shape of a hemispheroid formed by partially cutting away a dome of a spheroid from two different angles, a top surface formed by partially cutting away the dome of the spheroid from one angle inclines with respect to a bottom surface of the hemispheroid, and the top surface of the hemispheroid forms the first surface; or, the concave part is in the shape of a hemispheroid formed by partially cutting away a dome of a spheroid, a top surface formed by partially cutting away the dome of the spheroid inclines with respect to a bottom surface of the hemispheroid, and the top surface of the hemispheroid forms the first surface.

5. The light guide plate according to claim 1, wherein a depth (H1) of the concave part of the microstructure is 0.5 μm-20 μm, a height (H2) of the protruding part is 0.2 μm-3 μm, and a ratio of the depth (H1) of the concave part to the height (H2) of the protruding part of the microstructure is 4-12; or, a depth (H1) of the concave part of the microstructure is 0.2 μm-3 μm, a height (H2) of the protruding part is 0.5 μm-20 μm, and a ratio of the depth (H1) of the concave part to the height (H2) of the protruding part of the microstructure is 1/12-¼.

6. The light guide plate according to claim 1, wherein a length (L1) of the microstructure is 10 μm-150 μm, and a first width (W1) of the microstructure is 10 μm-150 μm, wherein the length refers to a size of the microstructure in a direction perpendicular to the light incident surface, and the first width refers to a size of the microstructure in a direction parallel to the light incident surface and the light exit surface.

7. The light guide plate according to claim 1, wherein the microstructure further comprises a third surface, the first surface is connected to the third surface, and part of the third surface and the first surface are two sides of the concave part respectively.

8. The light guide plate according to claim 7, wherein a section line, in a reference plane perpendicular to the light incident surface and the light exit surface, of the third surface is a second straight line, a second arc or a broken line, and an included angle between the second straight line and the bottom surface, between a tangent of the second arc and the bottom surface, or between the broken line and the bottom surface is 40°-80°.

9. The light guide plate according to claim 7, wherein a section line, in a reference plane parallel to the bottom surface, of the third surface on is a straight line; or, at least part of the third surface is a conical surface, and at least part of a section line, in a reference plane parallel to the bottom surface, of the third surface is an arc.

10. The light guide plate according to claim 7, wherein section lines, in a reference plane perpendicular to the light incident surface and the light exit surface, of the first surface and the third surface are in arc transition; and/or, arc transition is formed at a vertex of the protruding part.

11. A display assembly, comprising a light source, a light guide plate and a transmissive liquid crystal display panel, wherein the light guide plate is the light guide plate according to claim 1, the light source is arranged on a side of the light incident surface of the light guide plate, and the light guide plate is located on a backlight side of the transmissive liquid crystal display panel.

12. A display assembly, comprising a light source, a light guide plate and a reflective liquid crystal display panel, wherein the light guide plate is the light guide plate according to claim 1, the light source is arranged on a side of the light incident surface of the light guide plate, and the light guide plate is located on a light exit side of the reflective liquid crystal display panel.
